(19) United States
(12) Patent Application Publication
(10) Pub. No.: US 2021/0287124 A1
(43) Pub. Date: Sep. 16, 2021

(54) METHOD AND SYSTEM FOR ESTIMATING PHYSICAL QUANTITIES OF A PLURALITY OF MODELS USING A SAMPLING DEVICE

(71) Applicant: 1QB INFORMATION TECHNOLOGIES INC., Vancouver (CA)

(72) Inventors: Pooya RONAGH, Vancouver (CA); Navid GHADERMARZY, Burnaby (CA); Bohdan KULCHYTSKYY, Waterloo (CA); Anna LEVIT, Coquitlam (CA)

(21) Appl. No.: 17/196,825

(22) Filed: Mar. 9, 2021

Related U.S. Application Data
(60) Provisional application No. 62/987,655, filed on Mar. 10, 2020.

(51) Int. Cl. G06N 7/00; G06N 10/00

(52) U.S. Cl. CPC G06N 7/005; G06N 10/00

(57) ABSTRACT

A method is disclosed for estimating an expectation value of an observable of at least one target Hamiltonian using a base Hamiltonian, the method comprising obtaining an indication of a base Hamiltonian and an indication of an observable; setting a sampling device using the base Hamiltonian; obtaining from the sampling device a plurality of samples from a probability distribution defined by the base Hamiltonian; for each target Hamiltonian of a list of at least one target Hamiltonian: estimating an expectation value of the observable corresponding to the target Hamiltonian using the obtained plurality of samples from the probability distribution defined by the base Hamiltonian, the estimating comprising: computing a sample estimate of a ratio of partition functions of the target Hamiltonian and the base Hamiltonian, computing an unnormalized estimate for an expectation value of the observable with respect to the probability distribution defined by the target Hamiltonian, computing an estimate for an expectation value of the observable with respect to the probability distribution defined by the target Hamiltonian using the estimated ratio of partition functions and the unnormalized estimated expectation value; and providing the estimated expectation value of the observable corresponding to the target Hamiltonian.

### FIELD

One or more embodiments of the invention are directed towards estimation of physical quantities of a plurality of models using a sampling device. In particular, one or more embodiments of the invention enable estimating various observables of different models using a quantum device which cannot be configured to sample from these models.

### BACKGROUND

Nowadays the scientific community has come up with a whole bunch of different noisy intermediate-scale quantum (NISQ) devices as well as other physics-inspired devices and computers that are constantly being developed, improved and released. One of the useful tasks these machines are capable of performing is probabilistic sampling. It can be used for estimation and evaluation of various properties and functions for physical models. In particular, probabilistic sampling can be used in machine learning methods. Despite being capable of performing this task with a significant speedup due to the variety of quantum and/or other physics phenomena behind them, these machines are still limited in a lot of aspects, such as size, connectivity, depth and other characteristics defining model types which can be implemented on these machines.

Recognized herein is the need for at least one of a method and a system that will overcome at least one of the limitations associated with the limited types of models implemented on such computers.

### BRIEF SUMMARY

According to a broad aspect, there is disclosed a method for estimating an expectation value of an observable of at least one target Hamiltonian using a base Hamiltonian, the method comprising obtaining an indication of a base Hamiltonian and an indication of an observable; setting a sampling device using the base Hamiltonian; using said sampling device to obtain a plurality of samples from a probability distribution defined by the base Hamiltonian; for each target Hamiltonian of a list of at least one target Hamiltonian: using the obtained plurality of samples from the probability distribution defined by the base Hamiltonian to estimate an expectation value of the observable corresponding to the target Hamiltonian, the using comprising: computing a sample estimate of a ratio of partition functions of the target Hamiltonian and the base Hamiltonian, computing an unnormalized estimate for an expectation value of the observable with respect to the probability distribution defined by the target Hamiltonian, using the estimated ratio of partition functions and the unnormalized estimated expectation value to compute an estimate for the expectation value of the observable with respect to the probability distribution defined by the target Hamiltonian; and providing the estimated expectation value of the observable corresponding to the target Hamiltonian.

According to a broad aspect, there is disclosed a method for estimating maxima and arguments of maxima of parametrized negative of free energy defined by a family of target Hamiltonians represented by a parametrized target Hamiltonian, the method comprising: obtaining an indication of a family of base Hamiltonians; selecting an initial base Hamiltonian from the family of base Hamiltonians; obtaining an indication of a parametrized target Hamiltonian; until a first stopping criterion is met: updating a current base Hamiltonian, using the current base Hamiltonian to set a sampling device, using the sampling device to obtain a plurality of samples from a probability distribution defined by the current base Hamiltonian, selecting an initial parameter value, until a second stopping criterion is met: updating a parameter value, using the parametrized target Hamiltonian to obtain an indication of a target Hamiltonian corresponding to the parameter value, using the obtained samples from the probability distribution defined by the obtained base Hamiltonian to estimate a ratio of the target Hamiltonian corresponding to the parameter value and the current base Hamiltonian partition functions, estimating a free energy of the target Hamiltonian, providing the estimated ratio, the free energy defined by the obtained target Hamiltonian, and the corresponding parameter value; estimating at least one maximum and at least one argument of maxima of parametrized negative of free energy defined by the parametrized target Hamiltonian; and providing the at least one estimated maximum and the at least one estimated argument of maxima of the parametrized negative of free energy.

In accordance with one or more embodiments, the family of base Hamiltonians comprises one base Hamiltonian.

In accordance with one or more embodiments, the family of base Hamiltonians is represented by a parametrized base Hamiltonian.

In accordance with one or more embodiments, the current base Hamiltonian is updated using at least one optimization protocol based on a gradient based method.

In accordance with one or more embodiments, the current base Hamiltonian is updated using at least one optimization protocol based on a derivative free method.

In accordance with one or more embodiments, the updating of the current base Hamiltonian is performed using at least one optimization protocol based on a method selected from the group consisting of a gradient descent, a stochastic gradient descent, a steepest descent, a Bayesian optimization, a random search and a local search.

In accordance with one or more embodiments, the updating of the parameter value is performed using at least one optimization protocol based on a gradient based method.

In accordance with one or more embodiments, the updating of the parameter value is performed using at least one optimization protocol based on a derivative free method.

In accordance with one or more embodiments, the updating of the parameter value is performed using an optimization protocol based on at least one method selected from a group consisting of a gradient descent, a stochastic gradient descent, a steepest descent, a Bayesian optimization, a random search and a local search.

According to a broad aspect, there is disclosed a method for estimating maxima and arguments of maxima of negative of free energies defined by a family of target Hamiltonians using samples from a base Hamiltonian, the method comprising obtaining an indication of a base Hamiltonian; obtaining an indication of a family of target Hamiltonians; using the base Hamiltonian to set a sampling device; using the sampling device to obtain a plurality of samples from a probability distribution defined by the base Hamiltonian; for each target Hamiltonian of a list of target Hamiltonians representative of the family of target Hamiltonians: using the obtained samples from the probability distribution defined by the base Hamiltonian to estimate a ratio of the target Hamiltonian and the base Hamiltonian partition functions, storing the estimated ratio in a list, using the list of the estimated ratios to estimate at least one maximum of negative of free energies defined by the family of the target Hamiltonians, and providing the at least one estimated maximum of negative of free energies defined by the family of the target Hamiltonians.

According to a broad aspect, there is disclosed a method for estimating a difference between entropies of two models defined by a target Hamiltonian and a base Hamiltonian using a sampling device, the method comprising obtaining an indication of a base Hamiltonian; obtaining an indication of a target Hamiltonian; setting a sampling device using the base Hamiltonian; obtaining a plurality of samples from a probability distribution defined by the base Hamiltonian using the sampling device; estimating a ratio of the target Hamiltonian and the base Hamiltonian partition functions using the obtained samples; estimating an expectation value of energy observable corresponding to the target Hamiltonian using processing steps disclosed above; estimating a difference between entropies corresponding to the target Hamiltonian and to the base Hamiltonian using the estimated ratio and the estimated expectation value of the energy observable corresponding to the target Hamiltonian; and providing the estimated difference between entropies corresponding to the target Hamiltonian and to the base Hamiltonian.

According to one or more embodiments, the estimated expectation value of the observable comprises an energy function expected value.

According to one or more embodiments, the estimated expectation value of the observable comprises an n-point function.

According to one or more embodiments, the sampling device comprises a quantum processor operatively coupled to a processing device, further wherein the sampling device control system comprises a quantum processor control system.

According to one or more embodiments, the sampling device comprises a quantum computer.

According to one or more embodiments, the sampling device comprises a quantum annealer.

According to one or more embodiments, the sampling device comprises a noisy intermediate-scale quantum device.

According to one or more embodiments, the sampling device comprises a trapped ion quantum computer.

According to one or more embodiments, the sampling device comprises a superconductor-based quantum computer.

According to one or more embodiments, the sampling device comprises a spin-based quantum dot computer.

According to one or more embodiments, the sampling device comprises a digital annealer.

According to one or more embodiments, the sampling device comprises an integrated photonic coherent lsing machine.

According to one or more embodiments, the sampling device comprises an optical computing device operatively coupled to the processing device and configured to receive energy from an optical energy source and generate a plurality of optical parametric oscillators, and a plurality of coupling devices, each of which controllably couples a plurality of optical parametric oscillators.

According to one or more embodiments, the method further comprises using the estimated expectation value of the observable as a function approximator.

According to one or more embodiments, the method further comprises using the free energy as a function approximator.

According to one or more embodiments, the method further comprises estimating a thermodynamic property of a Hamiltonian and using thereof as a function approximator.

According to a broad aspect, there is disclosed a use of a method disclosed above for a training procedure within a reinforcement learning framework, the reinforcement learning framework comprising (i) an agent in pursuit of optimizing at least one utility function, (ii) an environment comprising states and instantaneous rewards and (iii) interactions of the agent with the environment comprising actions; wherein the instantaneous rewards contribute to the at least one utility function; the use comprising approximating the at least one utility function and estimating an action maximizing the at least one utility function corresponding to a provided state.

According to one or more embodiments, the at least one utility function is selected from a group consisting of a value function, a Q-function and a generalized advantage estimator.

One or more embodiments of the invention disclosed herein are of great advantages for various reasons. More precisely, an advantage of one or more embodiments of the methods disclosed herein is that they extend the functionality of a sampling device to estimate expectation values of observables of the models which are not configurable on the device.

Another advantage of one or more embodiments of the methods disclosed herein is that they enable comparing of various models using entropies.

Another advantage of one or more embodiments of the methods disclosed herein is that they enable estimating maxima and the arguments of maxima of negative free energy of a family of Hamiltonians using only one sampling.

Another advantage of one or more embodiments of the methods disclosed herein is that they may be implemented using various sampling devices.

Another advantage of the methods disclosed herein is that it may be applied in reinforcement learning.

### BRIEF DESCRIPTION OF THE DRAWINGS

In order that the invention may be readily understood, embodiments of the invention are illustrated by way of example in the accompanying drawings.

FIG. 1 is a diagram that shows an embodiment of a system comprising a digital system coupled to a sampling device comprising a quantum device.

FIG. 2 is a flowchart that shows an embodiment of a method for computing a sample estimate for a ratio of partition functions of two Hamiltonians.

FIG. 3 is a flowchart that shows an embodiment of a method for estimating the expectation values of the observables corresponding to the list of the Hamiltonians using the system shown in FIG. 1.

FIG. 4 is a flowchart that shows an embodiment of a procedure for estimating the expectation value of the observable corresponding to the target Hamiltonian using the samples obtained from the probability distribution defined by the base Hamiltonian.

FIG. 5 is a flowchart that shows an embodiment of a method for estimating a difference between entropies of two models defined by a target Hamiltonian and a base Hamiltonian.

FIG. 6 is a flowchart that shows an embodiment of a method for estimating the maxima and the arguments of maxima of the parametrized negative of the free energy defined by a family of target Hamiltonians represented by a parametrized target Hamiltonian.

FIG. 7 is a flowchart that shows an embodiment of a method for estimating the maxima and the arguments of maxima of the negative of the free energy defined by a family of target Hamiltonians.

### DETAILED DESCRIPTION

In the following description of the one or more embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an,” “the” and “at least one” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

As used herein, the term “analog computer” means a system comprising a quantum processor, control systems of qubits, coupling devices, and a readout system, all connected to each other through a communication bus.

As used herein, the terms “quantum computer” and “quantum device” means a system performing quantum computation, the computation using quantum-mechanical phenomena such as superposition and entanglement.

As used herein, the terms “reinforcement learning,” “reinforcement learning procedure,” and “reinforcement learning operation” generally refer to any system or computational procedure that takes one or more actions to enhance or maximize some notion of a cumulative reward to its interaction with an environment.

As used herein, the term “sampling device” generally refers to a system performing sampling from a probability distribution.

As used herein, the terms “target Hamiltonian” and “target model” generally refer to a Hamiltonian/model of interest, which corresponding probability distribution is not sampled using a sampling device.

As used herein, the term “physical quantity” generally refers to a property of a physical system that can be quantified by measurements.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

It will be appreciated that one or more embodiments of the invention may be implemented in numerous ways. In this specification, these implementations, or any other form that the invention may take, may be referred to as systems or techniques. A component such as a processor or a memory described as being configured to perform a task includes either a general component that is temporarily configured to perform the task at a given time or a specific component that is manufactured to perform the task.

With all this in mind, one or more embodiments of the present invention are directed to a method for estimating an expectation values of the observables of a plurality of models using a sampling device.

### Importance Sampling and Ratio Trick

Importance sampling is a general approach where samples generated from one probability distribution are used in order to extract unbiased information about another probability distribution. (See Statist. Sci., Volume 13, Number 2 (1998), 163-185. “Simulating normalizing constants: from importance sampling to bridge sampling to path sampling” by Andrew Gelman and Xiao-Li Meng; and “Efficient Multiple Importance Sampling Estimators” by Victor Elvira, Luca Martino, David Luengo, and Monica F. Bugallo. https://arxiv.org/pdf/1505.05391.pdf)

This is typically useful in situations when it is easier to sample from the generating distribution than from a target distribution. Another common use of the importance sampling is for the variance reduction.

A more specific application of importance sampling is evaluation of ratio of partition functions between two probability distributions. This particular usage of importance sampling is referred to as the ratio trick. The skilled addressee will appreciate that the ratio trick is an important tool in engineering and scientific applications. The ratio trick provides a method to access measurements of entanglement entropy in numerical studies of condensed matter systems. In Statistics and Computer Science, it may be used for evaluation of the performance of energy-based graphical models such as Boltzmann Machines.

### Physics-Inspired Computers

A physics-inspired computer may comprise one or more of: an optical computing device such as an optical parametric oscillator (OPO) and integrated photonic coherent lsing machine, a quantum computer, such as a quantum annealer, or a gate model quantum computer, an implementation of a physics-inspired method, such as simulated annealing, simulated quantum annealing, population annealing, quantum Monte Carlo and alike.

### Quantum Devices

Any type of quantum computers may be suitable for one or more embodiments of the technologies disclosed herein. In accordance with the description herein, suitable quantum computers may include, by way of non-limiting examples, superconducting quantum computers (qubits implemented as small superconducting circuits—Josephson junctions) (Clarke, John, and Frank K. Wilhelm. “Superconducting quantum bits.” Nature 453.7198 (2008): 1031); trapped ion quantum computers (qubits implemented as states of trapped ions) (Kielpinski, David, Chris Monroe, and David J. Wineland. “Architecture for a large-scale ion-trap quantum computer.” Nature 417.6890 (2002): 709.); optical lattice quantum computers (qubits implemented as states of neutral atoms trapped in an optical lattice) (Deutsch, Ivan H., Gavin K. Brennen, and Poul S. Jessen. “Quantum computing with neutral atoms in an optical lattice.” arXiv preprint quant-ph/0003022 (2000)); spin-based quantum dot computers (qubits implemented as the spin states of trapped electrons) (Imamog, A., David D. Awschalom, Guido Burkard, David P. DiVincenzo, Daniel Loss, M. Sherwin, and A. Small. “Quantum information processing using quantum dot spins and cavity QED.” arXiv preprint quant-ph/9904096 (1999)); spatial based quantum dot computers (qubits implemented as electron positions in a double quantum dot) (Fedichkin, Leonid, Maxim Yanchenko, and K. A. Valiev. “Novel coherent quantum bit using spatial quantization levels in semiconductor quantum dot.” arXiv preprint quant-ph/0006097 (2000)); coupled quantum wires (qubits implemented as pairs of quantum wires coupled by quantum point contact) (Bertoni, A., Paolo Bordone, Rossella Brunetti, Carlo Jacoboni, and S. Reggiani. “Quantum logic gates based on coherent electron transport in quantum wires.” Physical Review Letters 84, no. 25 (2000): 5912.); nuclear magnetic resonance quantum computers (qubits implemented as nuclear spins and probed by radio waves) (Cory, David G., Mark D. Price, and Timothy F. Havel. “Nuclear magnetic resonance spectroscopy: An experimentally accessible paradigm for quantum computing.” arXiv preprint quant-ph/9709001(1997)); solid-state NMR Kane quantum computers (qubits implemented as the nuclear spin states of phosphorus donors in silicon) (Kane, Bruce E. “A silicon-based nuclear spin quantum computer.” nature 393, no. 6681 (1998): 133.); electrons-on-helium quantum computers (qubits implemented as electron spins) (Lyon, Stephen Aplin. “Spin-based quantum computing using electrons on liquid helium.” arXiv preprint cond-mat/0301581 (2006)); cavity quantum electrodynamics-based quantum computers (qubits implemented as states of trapped atoms coupled to high-finesse cavities) (Burell, Zachary. “An Introduction to Quantum Computing using Cavity QED concepts.” arXiv preprint arXiv:1210.6512 (2012).); molecular magnet-based quantum computers (qubits implemented as spin states) (Leuenberger, Michael N., and Daniel Loss. “Quantum computing in molecular magnets.” arXiv preprint cond-mat/0011415 (2001)); fullerene-based ESR quantum computers (qubits implemented as electronic spins of atoms or molecules encased in fullerenes) (Harneit, Wolfgang. “Quantum Computing with Endohedral Fullerenes.” arXiv preprint arXiv:1708.09298 (2017).); linear optical quantum computers (qubits implemented as processing states of different modes of light through linear optical elements such as mirrors, beam splitters and phase shifters) (Knill, E., R. Laflamme, and G. Milburn. “Efficient linear optics quantum computation.” arXiv preprint quant-ph/0006088 (2000).); diamond-based quantum computers (qubits implemented as electronic or nuclear spins of nitrogen-vacancy centres in diamond) (Nizovtsev, A. P., S. Ya Kilin, F. Jelezko, T. Gaebal, lulian Popa, A. Gruber, and Jorg Wrachtrup. “A quantum computer based on NV centers in diamond: optically detected nutations of single electron and nuclear spins.” Optics and spectroscopy 99, no. 2 (2005): 233-244.); Bose-Einstein condensate-based quantum computers (qubits implemented as two-component BECs) (Byrnes, Tim, Kai Wen, and Yoshihisa Yamamoto. “Macroscopic quantum computation using Bose-Einstein condensates.” arXiv preprint quantum-ph/1103.5512 (2011)); transistor-based quantum computers (qubits implemented as semiconductors coupled to nanophotonic cavities) (Sun, Shuo, Hyochul Kim, Zhouchen Luo, Glenn S. Solomon, and Edo Waks. “A single-photon switch and transistor enabled by a solid-state quantum memory.” arXiv preprint quant-ph/1805.01964 (2018)); rare-earth-metal-ion-doped inorganic crystal-based quantum computers (qubits implemented as atomic ground state hyperfine levels in rare-earth-ion-doped inorganic crystals) (Ohlsson, Nicklas, R. Krishna Mohan, and Stefan KrOIL “Quantum computer hardware based on rare-earth-ion-doped inorganic crystals.” Optics communications 201, no. 1-3 (2002): 71-77.); metal-like carbon nanospheres based quantum computers (qubits implemented as electron spins in conducting carbon nanospheres) (Näfrädi, Báint, Mohammad Choucair, Klaus-Peter Dinse, and László Forró. “Room temperature manipulation of long lifetime spins in metallic-like carbon nanospheres.” arXiv preprint cond-mat/1611.07690 (2016)); and D-Wave's quantum annealers (qubits implemented as superconducting logic elements) (Johnson, Mark W., Mohammad HS Amin, Suzanne Gildert, Trevor Lanting, Firas Hamze, Neil Dickson, R. Harris et al. “Quantum annealing with manufactured spins.” Nature 473, no. 7346 (2011): 194-198.)

### NISQ—Noisy Intermediate-Scale Quantum Technology

The term Noisy Intermediate-Scale Quantum (NISQ) was introduced by John Preskill in “Quantum Computing in the NISQ era and beyond.” arXiv:1801.00862. Here, “Noisy” implies that we have incomplete control over the qubits and the “Intermediate-Scale” refers to the number of qubits which could range from 50 to a few hundreds. Several physical systems made from superconducting qubits, artificial atoms, ion traps are proposed so far as feasible candidates to build NISQ quantum device and ultimately universal quantum computers.

### Quantum Annealer

The skilled addressee will appreciate that a quantum annealer is a quantum mechanical system consisting of a plurality of manufactured qubits.

To each qubit is inductively coupled a source of bias called a local field bias. In one or more embodiments, a bias source is an electromagnetic device used to thread a magnetic flux through the qubit to provide control of the state of the qubit (see U.S. Patent Application No. 2006/0225165).

The local field biases on the qubits are programmable and controllable. In one or more embodiments, a qubit control system comprising a digital processing unit is connected to the system of qubits and is capable of programming and tuning the local field biases on the qubits.

A quantum annealer may furthermore comprise a plurality of couplings between a plurality of pairs of the plurality of qubits. In one or more embodiments, a coupling between two qubits is a device in proximity of both qubits threading a magnetic flux to both qubits. In the same embodiments, a coupling may consist of a superconducting circuit interrupted by a compound Josephson junction. A magnetic flux may thread the compound Josephson junction and consequently thread a magnetic flux on both qubits (See U.S. Patent Application No. 2006/0225165). The strength of this magnetic flux contributes quadratically to the energies of the quantum lsing model. In one or more embodiments, the coupling strength is enforced by tuning the coupling device in proximity of both qubits.

It will be appreciated that the coupling strengths may be controllable and programmable. In one or more embodiments, a quantum annealer control system comprising of a digital processing unit is connected to the plurality of couplings and is capable of programming the coupling strengths of the quantum annealer.

In one or more embodiments, the quantum annealer performs a transformation of the quantum lsing model with transverse field from an initial setup to a final one. In such embodiments, the initial and final setups of the quantum lsing model with transverse field provide quantum systems described by their corresponding initial and final Hamiltonians.

Quantum annealers can be used as heuristic optimizers of their energy function. An embodiment of such an analog processor is disclosed by McGeoch, Catherine C. and Cong Wang, (2013), “Experimental Evaluation of an Adiabatic Quantum System for Combinatorial Optimization” Computing Frontiers,” May 14 16, 2013 and also disclosed in the Patent Application US 2006/0225165.

Quantum annealers may be used to provide samples from the Boltzmann distribution of corresponding lsing model in a finite temperature. (Bian, Z., Chudak, F., Macready, W. G. and Rose, G. (2010), “The lsing model: teaching an old problem new tricks”, and also Amin, M. H., Andriyash, E., Rolfe, J., Kulchytskyy, B., and Melko, R. (2016), “Quantum Boltzmann Machine” arXiv:1601.02036.)

This method of sampling is called quantum sampling.

### Optical Computing Devices

Another embodiment of an analogue system capable of performing sampling from Boltzmann distribution of an lsing model near its equilibrium state is an optical device.

In one or more embodiments, the optical device comprises a network of optical parametric oscillators (OPOs) as disclosed in the patent applications US20160162798 and WO2015006494 A1.

In such embodiments, each spin of the lsing model is simulated by an optical parametric oscillator (OPO) operating at degeneracy.

Degenerate optical parametric oscillators (OPOs) are open dissipative systems that experience second order phase transition at the oscillation threshold. Because of the phase-sensitive amplification, a degenerate optical parametric oscillator (OPO) could oscillate with a phase of either 0 or π with respect to the pump phase for amplitudes above the threshold. The phase is random, affected by the quantum noise associated in optical parametric down conversion during the oscillation build-up. Therefore, a degenerate optical parametric oscillator (OPO) naturally represents a binary digit specified by its output phase. Based on this property, a degenerate optical parametric oscillator (OPO) system may be utilized as a physical representative of an lsing spin system. The phase of each degenerate optical parametric oscillator (OPO) is identified as an lsing spin, with its amplitude and phase determined by the strength and the sign of the lsing coupling between relevant spins.

When pumped by a strong source, a degenerate optical parametric oscillator (OPO) takes one of two phase states corresponding to spin+1 or −1 in the lsing model. A network of N substantially identical optical parametric oscillators (OPOs) with mutual coupling are pumped with the same source to simulate an lsing spin system. After a transient period from introduction of the pump, the network of optical parametric oscillators (OPOs) approaches to a steady state close to its thermal equilibrium.

The phase state selection process depends on the vacuum fluctuations and mutual coupling of the optical parametric oscillators (OPOs). In some implementations, the pump is pulsed at a constant amplitude, in other implementations the pump output is gradually increased, and in yet further implementations, the pump is controlled in other ways.

In one or more embodiments of an optical device, the plurality of couplings of the lsing model are simulated by a plurality of configurable couplings used for coupling the optical fields between optical parametric oscillators (OPOs). The configurable couplings may be configured to be off or configured to be on. Turning the couplings on and off may be performed gradually or abruptly. When configured to be on, the configuration may provide any phase or amplitude depending on the coupling strengths of the lsing model.

Each optical parametric oscillator (OPO) output is interfered with a phase reference and the result is captured at a photodetector. The optical parametric oscillator (OPO) outputs represent a configuration of the lsing model. For example, a zero phase may represent a spin −1 state, and a π phase may represent a +1 spin state in the lsing model.

For the lsing model with spins, and according to one or more embodiments, a resonant cavity of the plurality of optical parametric oscillators (OPOs) is configured to have a round-trip time equal to times the period of pulses from a pump source. Round-trip time as used herein indicates the time for light to propagate along one pass of a described recursive path. The pulses of a pulse train with period equal to of the resonator cavity round-trip time may propagate through the optical parametric oscillators (OPOs) concurrently without interfering with each other.

In one or more embodiments, the couplings of the optical parametric oscillators (OPOs) are provided by a plurality of delay lines allocated along the resonator cavity.

The plurality of delay lines comprise a plurality of modulators which synchronously control the strengths and phases of couplings, allowing for programming of the optical device to simulate the lsing model.

In a network of optical parametric oscillators (OPOs), delay lines and corresponding modulators is enough to control amplitude and phase of coupling between every two optical parametric oscillators (OPOs).

In one or more embodiments, an optimal device, capable of sampling from an lsing model can be manufactured as a network of optical parametric oscillators (OPOs) as disclosed in US Patent Application No 20160162798.

In one or more embodiments, the network of optical parametric oscillators (OPOs) and couplings of the optical parametric oscillators (OPOs) can be achieved using commercially available mode locked lasers and optical elements such as telecom fiber delay lines, modulators, and other optical devices. Alternatively, the network of optical parametric oscillators (OPOs) and couplings of optical parametric oscillators (OPOs) can be implemented using optical fiber technologies, such as fiber technologies developed for telecommunications applications. The couplings can be realized with fibers and controlled by optical Kerr shutters.

Integrated Photonic Coherent lsing Machine

Another embodiment of an analogue system capable of performing sampling from Boltzmann distribution of an lsing model near its equilibrium state is an Integrated photonic coherent lsing machine disclosed in patent application No US20180267937A1.

In one or more embodiments, an Integrated photonic coherent lsing machine is a combination of nodes and a connection network solving a particular lsing problem. In such embodiments, the combination of nodes and the connection network may form an optical computer that is adiabatic. In other words, the combination of the nodes and the connection network may non-deterministically solve an lsing problem when the values stored in the nodes reach a steady state to minimize the energy of the nodes and the connection network. Values stored in the nodes at the minimum energy level may be associated with values that solve a particular lsing problem. The stochastic solutions may be used as samples from the Boltzmann distribution defined by the Hamiltonian corresponding to the lsing problem.

In such embodiments, a system may comprise a plurality of ring resonator photonic nodes, wherein each one of the plurality of ring resonator photonic nodes stores a value; a pump coupled to each one of the plurality of ring resonator photonic nodes via a pump waveguide for providing energy to each one of the plurality of ring resonator photonic nodes; and a connection network comprising a plurality of two by two building block of elements, wherein each element of the two by two building block comprises a plurality of phase shifters for tuning the connection network with parameters associated with encoding of an lsing problem, wherein the connection network processes the value stored in the each one of the plurality of ring resonator photonic nodes, wherein the lsing problem is solved by the value stored in the each one of the plurality of ring resonator photonic nodes at a minimum energy level.

### Digital Annealer

Digital annealer refers to a digital annealing unit such as those developed by Fujitsu™.

### Boltzmann Distribution Sampling Using a Quantum Computer

Boltzmann distribution sampling from a classical Hamiltonian defined by a classical energy function operating on the space of configurations using a quantum computer may be performed in various ways. The Boltzmann distribution sampling may comprise Gibbs state preparation. The sampling procedure approach and the Gibbs state preparation may depend on the particularities of the quantum hardware.

In quantum circuit approach, the Boltzmann distribution over the variables of the classical Hamiltonian results from their coherent interactions with auxiliary units as dictated by the sequence of quantum circuit gates specified by a particular algorithm. These algorithms comprise three main steps: initialization of qubits, followed by a set of operations subjecting these qubits to a unitary transformation and, finally, a measurement of the qubits final state and its processing.

It will be appreciated that the Boltzmann distribution sampling may be based on a procedure Hamiltonian evolution. In such embodiments, a common subroutine is emulating the action of the procedure Hamiltonian time-evolution on system qubits associated with the variables and, possibly, ancilla qubits. The choice of the procedure Hamiltonian is procedure-dependent and is directly derived from the classical Hamiltonian defining the Boltzmann distribution to sample from. Anirban Narayan Chowdhury and Rolando D. Somma in “Quantum algorithms for Gibbs sampling and hitting-time estimation” (2017 arXiv:1603.02940), which is incorporated herein by reference, derive procedure Hamiltonian from a mathematical decomposition of the expression for the Boltzmann distribution at twice the temperature into a linear set of unitary matrices. These unitary matrices, therefore, follow directly from the classical Hamiltonian and define the derived procedure Hamiltonian. In “Sampling from the thermal quantum Gibbs state and evaluating partition functions with a quantum computer” (2009 arXiv:0905.2199) by David Poulin and Pawel Wocjan, which is incorporated herein by reference, the derived procedure Hamiltonian is exactly the classical Hamiltonian defining the Boltzmann distribution to sample from. In “The problem of equilibration and the computation of correlation functions on a quantum computer” (2000 arXiv:quant-ph/9810063) by Barbara M. Terhal and David P. DiVincenzo, which is incorporated herein by reference, the derived procedure Hamiltonian comprises the classical Hamiltonian, an auxiliary non-interacting Hamiltonian that acts on the ancilla qubits and Hamiltonian that couples two subsystems by combining the terms present in the classical and the auxiliary non-interacting Hamiltonians. In this disclosure, oracular implementations of the procedures may be considered. The simulations of the corresponding derived procedure Hamiltonian may be achieved by employing quantum oracles that are queried to yield values related to the derived procedure Hamiltonian.

In “The problem of equilibration and the computation of correlation functions on a quantum computer” (2000 arXiv:quant-ph/9810063) by Barbara M. Terhal and David P. DiVincenzo, all system qubits are initialized to all zeros state. The initial state of the ancilla qubits is prepared to a Gibbs state. Specifically, via a random Bernoulli process, each ancilla qubit is independently set to state one or zero with a probability determined from the eigenvalue of the associated auxiliary non-interacting ancilla Hamiltonian term. Then, each ancilla qubit is rotated into one of its two eigenstates in correspondence with the qubit's sampled binary state. After initialization, all the qubits are subjected to a unitary transformation under the action of the derived procedure Hamiltonian time-evolution for a sufficiently long time. Finally, the states of the system qubits are measured yielding a sample from the Boltzmann distribution defined by the classical Hamiltonian.

In “Sampling from the thermal quantum Gibbs state and evaluating partition functions with a quantum computer” (2009 arXiv:0905.2199) by David Poulin and Pawel Wocjan, the ancilla qubits are subdivided into two subcategories: scratchpad and energy registers. Qubits that are part of the system and the scratchpad registers are prepared in a maximally entangled state while the qubits in the energy register are set to the zero state. Quantum phase estimation is then applied to the qubits in the system and energy registers. This operation incorporates Hadamard transform, a controlled Hamiltonian time-evolution and quantum Fourier transform as its subroutines. The resulting state of the system register corresponds to the Boltzmann state at infinite temperature. The targeted finite temperature state is obtained by applying a controlled rotation to an additional auxiliary qubit conditioned by the state of the energy register. A sample of the Boltzmann distribution defined by the classical Hamiltonian is then obtained by performing a measurement on the system qubits and the auxiliary qubit and post-selecting measurements with the auxiliary qubit being in the state zero.

In “Quantum algorithms for Gibbs sampling and hitting-time estimation” (2017 arXiv:1603.02940) by Anirban Narayan Chowdhury and Rolando D. Somma, the ancilla qubits are divided in subcategories. The ancilla scratchpad qubits are prepared in a maximally entangled state with the system qubits. Another set of ancilla qubits are initially prepared in the zero state. These qubits are used as a control set in the application of linear combination of unitaries (LCU) operation on the system qubits. For its operation, linear combination of unitaries (LCU) relies on the controlled Hamiltonian time-evolution operation as a primitive. After linear combination of unitaries (LCU) circuit is applied, the states of the ancilla qubits that are used in the linear combination of unitaries (LCU) and system qubits are measured. A sample of the Boltzmann distribution defined by the classical Hamiltonian is obtained by post-selecting measurements with the auxiliary qubit being in the state zero.

It will be appreciated that the Boltzmann distribution sampling may be based on a quantum random walk. This approach relies on a quantum formulation of a classical random walk designed to sample from the Boltzmann distribution defined by the classical Hamiltonian. The classical random walk is mathematically defined by a Markov transition operator which is assumed to be aperiodic and reversible. In “Efficient Quantum Walk Circuits for Metropolis-Hastings Algorithm” (2020 arXiv:1910.01659) by Jessica Lemieux, Bettina Heim, David Poulin, Krysta Svore and Matthias Troyer, which is incorporated herein by reference, a quantum random walk operator is formulated using the Markov transition operator. This formulated quantum random walk operator acts on an extended system comprising system n qubits associated with the variables of the classical Hamiltonian as well as of n+1 ancilla qubits. All of the system qubits are initialized into a state of equal superposition in the computational basis and the ancilla qubits are set to the all-zeros state. The quantum operator is applied repeatedly to the full system for a sufficient number of times. A sample of the Boltzmann distribution defined by the classical Hamiltonian is obtained via measurement of the system qubits.

It will be appreciated that the Boltzmann distribution sampling may be performed using a quantum annealer. The classical Hamiltonian is specified by setting a target set of couplings on the physical device. The system is then initialized with an easy-to-prepare ground state of an initial non-interacting Hamiltonian. The system is relaxed into a thermal state under natural dynamics of the initial Hamiltonian and its environment. Next, the Hamiltonian couplings are slowly modified from their initial values to the values of the classical Hamiltonian. As this transition takes place, the state of the system tracks the Boltzmann distribution defined by the classical Hamiltonian. In the end of this interpolation to the classical Hamiltonian, the state is measured, producing a single sample of the base Boltzmann distribution defined by the classical Hamiltonian. More details can be found in “Adiabaticity in open quantum systems” (2016 arXiv:1508.05558) by Lorenzo Campos Venuti, Tameem Albash, Daniel A. Lida and Paolo Zanardi which is incorporated herein by reference.

### Reinforcement Learning

Reinforcement learning generally refers to any system or computational procedure that takes one or more actions to enhance or maximize some notion of a cumulative reward to its interaction with an environment. The agent performing the reinforcement learning (RL) may receive positive or negative reinforcements, called an “instantaneous reward”, from taking one or more actions in the environment and therefore placing itself and the environment in various new states.

A goal of the agent may be to enhance or maximize some notion of cumulative reward. For instance, the goal of the agent may be to enhance or maximize a “discounted reward function” or an “average reward function”. A “Q-function” may represent the maximum cumulative reward obtainable from a state and an action taken at that state. A “value function” and a “generalized advantage estimator” may represent the maximum cumulative reward obtainable from a state given an optimal or best choice of actions. Reinforcement learning (RL) may use any one of more of such notions of cumulative reward. As used herein, any such function may be referred to as a “cumulative reward function”. Therefore, computing a best or optimal cumulative reward function may be equivalent to finding a best or optimal policy for the agent.

The agent and its interaction with the environment may be formulated as one or more Markov Decision Processes (MDPs). The reinforcement learning (RL) procedure may not assume knowledge of an exact mathematical model of the Markov Decision Processes (MDPs). The Markov Decision Processes (MDPs) may be completely unknown, partially known, or completely known to the agent. The reinforcement learning (RL) procedure may sit in a spectrum between the two extents of “model-based” or “model-free” with respect to prior knowledge of the Markov Decision Processes (MDPs). As such, the reinforcement learning (RL) procedure may target large Markov Decision Processes (MDPs) where exact methods may be infeasible or unavailable due to an unknown or stochastic nature of the Markov Decision Processes (MDPs).

The reinforcement learning (RL) procedure may be implemented using a digital processing unit. The digital processing unit may implement an agent that trains, stores, and later on deploys a “policy” to enhance or maximize the cumulative reward. The policy may be sought (for instance, searched for) for a period of time that is as long as possible or desired. Such an optimization problem may be solved by storing an approximation of an optimal policy, by storing an approximation of a cumulative reward function, or both. In some cases, reinforcement learning (RL) procedures may store one or more tables of approximate values for such functions. In other cases, reinforcement learning (RL) procedure may utilize one or more “function approximators”.

Examples of function approximators may include neural networks, such as deep neural networks, and probabilistic graphical models, e.g. Boltzmann machines, Helmholtz machines, and Hopfield networks. A function approximator may create a parameterization of the approximation of the cumulative reward function. Optimization of the function approximator with respect to its parameterization may consist of perturbing the parameters in a direction that enhances or maximizes the cumulative rewards and therefore enhances or optimizes the policy, such as in a policy gradient method, or by perturbing the function approximator to get closer to satisfy Bellman's optimality criteria, such as in a temporal difference method.

During training, the agent may take actions in the environment to obtain more information about the environment and about good or best choices of policies for survival or better utility. The actions of the agent may be randomly generated, for instance, especially in early stages of training, or may be prescribed by another machine learning paradigm, such as supervised learning, imitation learning, or any other machine learning procedure. The actions of the agent may be refined by selecting actions closer to the agent's perception of what an enhanced or optimal policy is. Various training strategies may sit in a spectrum between the two extents of off-policy and on-policy methods with respect to choices between exploration and exploitation.

Reinforcement learning (RL) procedures may comprise deep reinforcement learning (DRL) procedures, such as those disclosed in [Mnih et al., Playing Atari with Deep Reinforcement Learning, arXiv:1312.5602 (2013)], [Schulman et al., Proximal Policy Optimization Algorithms, arXiv:1707.06347 (2017)], [Konda et al., Actor-Critic Algorithms, in Advances in Neural Information Processing Systems, pp. 1008-1014 (2000)], and [Mnih et al., Asynchronous Methods for Deep Reinforcement Learning, in International Conference on Machine Learning, pp. 1928-1937 (2016)], each of which is incorporated herein by reference in its entirety.

Reinforcement learning (RL) procedures may also be referred to as “approximate dynamic programming” or “neuro-dynamic programming”.

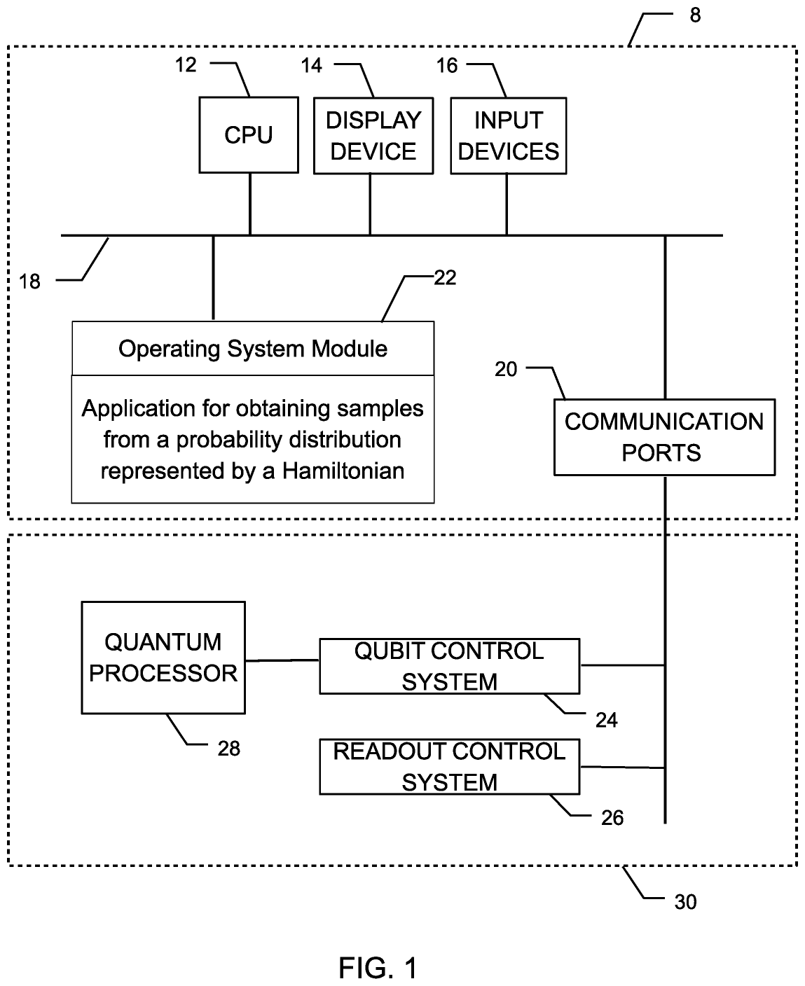

Now referring to FIG. 1, there is shown a diagram that shows an embodiment of a system comprising a digital system 8 coupled to a sampling device comprising a quantum device 30.

It will be appreciated that the digital computer 8 may be any type of digital computer.

In one or more embodiments, the digital computer 8 is selected from a group consisting of desktop computers, laptop computers, tablet PC's, servers, smartphones, etc. It will also be appreciated that, in the foregoing, the digital computer 8 may also be broadly referred to as a processor.

In the embodiment shown in FIG. 1, the digital computer 8 comprises a central processing unit 12, also referred to as a microprocessor, a display device 14, input devices 16, communication ports 20, a data bus 18 and a memory unit 22.

The central processing unit 12 is used for processing computer instructions. The skilled addressee will appreciate that various embodiments of the central processing unit 12 may be provided.

In one or more embodiments, the central processing unit 12 comprises a CPU Core i5 3210 running at 2.5 GHz and manufactured by Intel™.

The display device 14 is used for displaying data to a user. The skilled addressee will appreciate that various types of display device 14 may be used.

In one or more embodiments, the display device 14 is a standard liquid crystal display (LCD) monitor.

The input devices 16 are used for inputting data into the digital computer 8.

The communication ports 20 are used for sharing data with the digital computer 8.

The communication ports 20 may comprise, for instance, universal serial bus (USB) ports for connecting a keyboard and a mouse to the digital computer 8.

The communication ports 20 may further comprise a data network communication port, such as IEEE 802.3 port, for enabling a connection of the digital computer 8 with a quantum device 30.

The skilled addressee will appreciate that various alternative embodiments of the communication ports 20 may be provided.

The memory unit 22 is used for storing computer-executable instructions.

The memory unit 22 may comprise a system memory, such as a high-speed random-access memory (RAM), for storing system control program (e.g., BIOS, operating system module, applications, etc.) and a read-only memory (ROM).

It will be appreciated that the memory unit 22 comprises, in one or more embodiments, an operating system module.

It will be appreciated that the operating system module may be of various types.

In one or more embodiments, the operating system module is OS X Catalina manufactured by Apple™.

In the embodiment shown in FIG. 1, the sampling device comprises a quantum device 30. It will be appreciated that the sampling device may comprise any physics-inspired computer described herein. In one or more embodiments, the sampling device comprises a noisy intermediate-scale quantum device. The sampling device may comprise at least one member of a group consisting of an optical parametric oscillator (OPO), integrated photonic coherent lsing machine, a quantum computer, a quantum annealer, a gate model quantum computer and an implementation of a physics-inspired method, such as simulated annealing, simulated quantum annealing, population annealing and quantum Monte Carlo.

The quantum device 30 comprises a quantum circuit control system 24, a readout control system 26 and a quantum processor 28.

The memory unit 22 further comprises an application for obtaining samples from a probability distribution represented by a Hamiltonian implemented on quantum processor 28 of the quantum device 30.

The memory unit 22 may further comprise an application for using the quantum device 30, not shown.

The memory unit 22 may further comprise quantum processor data, not shown, such as a corresponding input data, encoding pattern of the input data into single- and two-qubit gates in the quantum processor 28.

The quantum processor 28 may be of various types. In one or more embodiments, the quantum processor 28 comprises superconducting qubits.

The readout control system 26 is used for reading the qubits of the quantum processor 28. In fact, it will be appreciated that in order for a quantum processor to be used in the method disclosed herein, a readout system that measures the qubits of the quantum system in their quantum mechanical states is required. Multiple measurements provide a sample of the states of the qubits. The results from the readings are fed to the digital computer 8. The quantum circuit structure is controlled via quantum circuit control system 24.

It will be appreciated that the readout control system 26 may be of various types. For instance, the readout control system 26 may comprise a plurality of dc-SQUID magnetometers, each inductively connected to a different qubit of the quantum processor 28. The readout control system 26 may provide voltage or current values. In one or more embodiments, the dc-SQUID magnetometer comprises a loop of superconducting material interrupted by at least one Josephson junction, as is well known in the art.

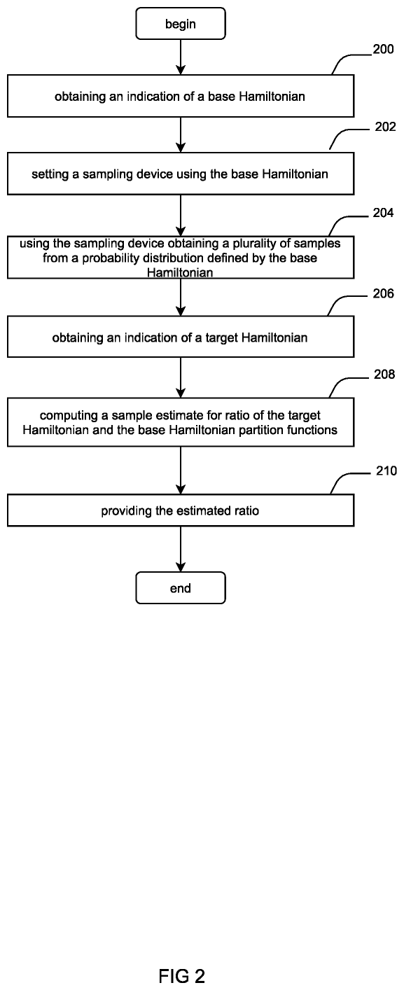

Now referring to FIG. 2, there is shown an embodiment of a method for estimating a ratio of a target Hamiltonian and the base Hamiltonian partition functions using a sampling device.

According to processing step 200, an indication of a base Hamiltonian is obtained. It will be appreciated that the indication of a base Hamiltonian may be of various types. In one or more embodiments, the indication of the base Hamiltonian is a mathematical function representing the energy function.

It will be appreciated that the indication of the base Hamiltonian may be obtained according to various embodiments.

In one or more embodiments, the indication of the base Hamiltonian is obtained using the digital computer 8. It will be appreciated that the indication of the base Hamiltonian may be stored in the memory unit 22 of the digital computer 8.

In an alternative embodiment, the indication of the base Hamiltonian is provided by a user interacting with the digital computer 8.

In an alternative embodiment, the indication of the base Hamiltonian is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one embodiment, the data network comprises the Internet.

It will be appreciated by the skilled addressee that the base Hamiltonian defines a physics model and the Boltzmann probability distribution corresponding to the model. More precisely, let E_{b} define a base Hamiltonian. It is defined via a classical energy function operating on the space of configurations. For a given configuration c, the base Hamiltonian outputs a real number representative of the energy E_{b}(c). In one embodiment, a configuration c is a binary vector. The probability distribution corresponding to the base Hamiltonian over all possible configurations is specified by the Boltzmann distribution

$${p}_{b} ( c ) = \frac{{e}^{- {E}_{b} ( c )}}{{Z}_{b}} ,$$

where the normalizing constant, Z_{b}=Σᵢe^{-E(c}^{ᵢ}⁾, is the partition function.

According to processing step 202, a sampling device is set using the obtained base Hamiltonian. The skilled addressee will appreciate that the sampling device may comprise any physics-inspired computer described herein. For instance and in one or more embodiments, the sampling device comprises a NISQs device. It will be appreciated that the sampling device may be any suitable sampling device, such as any sampling device described herein with respect to the system shown in FIG. 1. It will be appreciated that the sampling device may be set in various ways which may depend on the type of the sampling device for example, as disclosed elsewhere herein.

Still referring to FIG. 2 and according to processing step 204, a plurality of samples from a probability distribution defined by the base Hamiltonian is obtained using the sampling device. It will be appreciated that the base Hamiltonian is such that it can be implemented on the sampling device. It will be further appreciated that the plurality of samples may be obtained in various ways which may depend on the type of the sampling device and the procedure used for the sampling from the Boltzmann distribution defined by the base Hamiltonian for example as disclosed elsewhere herein.

For a given E_{b}, the output of the sampling device is a plurality of configuration samples {c}Nᵢ₌₁^{N}^{ₛ}, wherein Nₛ is the number of samples. In one or more embodiments, the number of samples Nₛ is provided by a user. The skilled addressee will appreciate that in the one or more embodiments, wherein the sampling device is a quantum computer, multiple measurements of the states of the qubits provide the plurality of samples from the probability distribution defined by the base Hamiltonian.

According to processing step 206, an indication of a target Hamiltonian is obtained. The indication may be a mathematical function representing the energy function. It will be appreciated that the indication of the target Hamiltonian may be obtained according to various embodiments.

In one or more embodiments, the indication of the target Hamiltonian is obtained using the digital computer 8. It will be appreciated that the indication of the target Hamiltonian may be stored in the memory unit 22 of the digital computer 8.

In one or more alternative embodiments, the indication of the target Hamiltonian is provided by a user interacting with the digital computer 8.

In one or more alternative embodiments, the indication of the target Hamiltonian is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

More precisely, let Eₜ be the target Hamiltonian. The skilled addressee will appreciate that the concepts of the partition function and Boltzmann probability distributions extend to the target Hamiltonian. However, it will be appreciated by the skilled addressee that unlike the base Hamiltonian, the sampling device will not be used to sample from the distribution defined by the target Hamiltonian. It will be appreciated by the skilled addressee that the configuration space of the target Hamiltonian is the same as that of the base Hamiltonian.

Still referring to FIG. 2 and according to processing step 208, a sample estimate for a ratio of the target Hamiltonian and the base Hamiltonian partition functions is computed using the obtained configuration samples {c}ᵢ₌₁^{N}^{ₛ}, which samples are from the probability distribution defined by the base Hamiltonian. More precisely, a sample estimate for a ratio of the base Hamiltonian and the target Hamiltonian partition functions is computed using the following equation

$${r}_{b}^{t} = \frac{1}{{N}_{s}} {Σ}_{i = 1}^{{N}_{s}} \frac{{e}^{- {E}_{t} ( {c}_{i} )}}{{e}^{- {E}_{b} ( {c}_{i} )}} .$$

According to processing step 210, the estimated ratio is provided. It will be appreciated that the estimated ratio may be provided according to various embodiments. In one or more embodiments, the estimated ratio is stored in the memory unit 22. In one or more alternative embodiments, the estimated ratio is displayed on the display device 14. In one or more alternative embodiments, the estimated ratio is provided to a remote processing device operatively connected to the digital computer 8. In fact and as further explained below, it will be appreciated that the estimated ratio may be advantageously used in many embodiments.

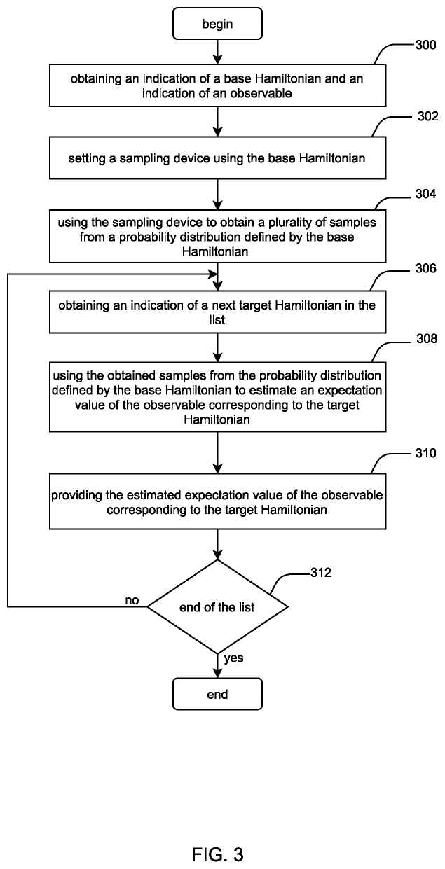

Now referring to FIG. 3, there is shown an embodiment of a method for estimating an expectation value of an observable of at least one target model using a base Hamiltonian using a sampling device. It will be appreciated that the method disclosed herein provides an unbiased estimation of an expectation value of the observable corresponding to the target Hamiltonian based on the samples generated by the sampling device configured to sample from the distribution defined by the base Hamiltonian.

The skilled addressee will appreciate that in one or more embodiments, the observable is an energy function of the Boltzmann distribution. It will be further appreciated that in one or more different embodiments the observable is an n-point function.

Still referring to FIG. 3 and according to processing step 300, an indication of a base Hamiltonian and an indication of an observable A are obtained. It will be appreciated that the indication of the base Hamiltonian may be of various types. In one or more embodiments, the indication of the base Hamiltonian is a mathematical function representing the energy function.

It will be appreciated that the indication of the base Hamiltonian and the indication of the observable may be obtained according to various embodiments.

In one or more embodiments, the indication of the base Hamiltonian and the indication of the observable are obtained using the digital computer 8. It will be appreciated that the indication of the base Hamiltonian and the indication of the observable may be stored in the memory unit 22 of the digital computer 8.

In one or more alternative embodiments, the indication of the base Hamiltonian and the indication of the observable are provided by a user interacting with the digital computer 8.

In one or more alternative embodiments, the indication of the base Hamiltonian and the indication of the observable are obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

It will be appreciated by the skilled addressee that the base Hamiltonian defines a physics model and the Boltzmann probability distribution corresponding to the model. More precisely, let E_{b} define the base Hamiltonian. It is defined via a classical energy function operating on the space of configurations. For a given configuration c, the base Hamiltonian outputs a real number representative of the energy E_{b}(c). In one or more embodiments, the configuration c is a binary vector. The probability distribution corresponding to the base Hamiltonian over all possible configurations is specified by the Boltzmann probability distribution

$${p}_{b} ( c ) = \frac{{e}^{- {E}_{b} ( c )}}{{Z}_{b}} ,$$

where the normalizing constant, Z_{b}=Σᵢe^{-E(c}^{ᵢ}⁾, is the partition function.

Still referring to FIG. 3 and according to processing step 302, the sampling device is set using the base Hamiltonian. It will be appreciated that the sampling device may be of various types. The skilled addressee will appreciate that the sampling device may comprise any physics-inspired computer described herein. For instance and in one or more embodiments, the sampling device comprises a NISQs device. It will be appreciated that the sampling device may be any suitable sampling device, such as any sampling device described herein with respect to the system shown in FIG. 1. It will be appreciated that the sampling device may be set in various ways which may depend on the type of the sampling device for example as disclosed elsewhere herein.

According to processing step 304, a plurality of samples from a probability distribution defined by the base Hamiltonian is obtained using the sampling device. It will be appreciated by the skilled addressee that the base Hamiltonian is such that it can be implemented on the sampling device. It will be further appreciated that the plurality of samples may be obtained in various ways which may depend on the type of the sampling device and the procedure used for the sampling from the Boltzmann distribution defined by the base Hamiltonian for example as disclosed elsewhere herein.

For a given E_{b}, the output of the sampling device is a plurality of configuration samples {c}ᵢ₌₁^{N}^{ₛ}, wherein Nₛ is the number of samples. It will be appreciated that in one or more embodiments, the number of samples Nₛ is provided by a user. The skilled addressee will appreciate that in the one or more embodiments, wherein the sampling device is a quantum computer, multiple measurements of the states of the qubits provide the plurality of samples from the probability distribution defined by the base Hamiltonian.

According to processing step 306, an indication of a next target Hamiltonian is obtained. The indication of the next target Hamiltonian may be a mathematical function representing the energy function. It will be appreciated that the indication of the target Hamiltonian may be obtained according to various embodiments.

In one or more embodiments, the indication of the next target Hamiltonian is obtained using the digital computer 8. It will be appreciated that the indication of the next target Hamiltonian may be stored in the memory unit 22 of the digital computer 8.

In one or more alternative embodiments, the indication of the next target Hamiltonian is provided by a user interacting with the digital computer 8.

In one or more alternative embodiments, the indication of the next target Hamiltonian is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

More precisely, let Eₜ be a target Hamiltonian. The concepts of the Boltzmann probability distributions and samples introduced above for the base Hamiltonian extend to the target Hamiltonian as well. However, unlike the base Hamiltonian, it will be appreciated by the skilled addressee that the sampling device will not be used to sample from the distribution defined by the target Hamiltonian. It will be appreciated by the skilled addressee that the configuration space of the target Hamiltonian is the same as that of the base Hamiltonian. It will be appreciated by the skilled addressee that estimating the observables at the equilibrium may be useful in various applications. An observable is described by a function A(c) which outputs a vector evaluated on a configuration c. In one or more embodiments, the target Hamiltonian energy Eₜ(c) is an observable. It will be appreciated that there is an interest for evaluating the expected value of an observable with respect to the distribution defined by the target Hamiltonian. The expectation value is defined by [symbol] Aₚ_{ₜ} [symbol] =Σ_{c} pₜ(c)A(c). Here the notation on the left-hand side specifies the observable of interest as well as the probability distribution with respect to which it may be evaluated.

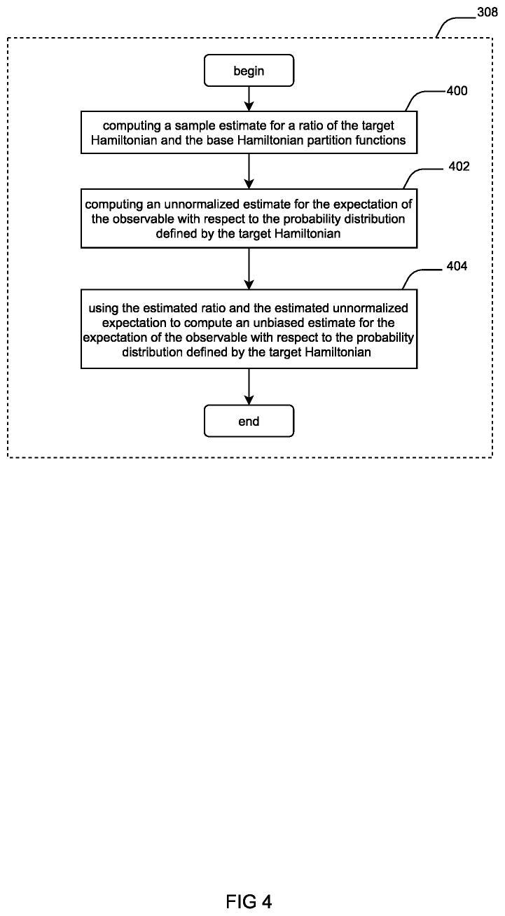

Still referring to FIG. 3 and according to the processing step 308, an expectation value of the observable corresponding to the target Hamiltonian is estimated using the obtained samples from the probability distribution defined by the base Hamiltonian. More precisely, the estimating of the expectation value of the observable is performed according to the method disclosed in FIG. 4 in accordance with one or more embodiments.

Now referring to FIG. 4 and according to processing step 400, a sample estimate for a ratio of the base Hamiltonian and the target Hamiltonian partition functions is computed using the following equation

$${r}_{b}^{t} = \frac{1}{{N}_{s}} {Σ}_{i = 1}^{{N}_{s}} \frac{{e}^{- {E}_{t} ( {c}_{i} )}}{{e}^{- {E}_{b} ( {c}_{i} )}} .$$

Still referring to FIG. 4 and according to processing step 402, an unnormalized estimate for the expectation value of the observable A with respect to the distribution pₜ defined by the target Hamiltonian is computed via

$${\tilde{A}}_{{p}_{t}} = \frac{1}{{N}_{s}} {Σ}_{i = 1}^{{N}_{s}} A ( {c}_{i} ) \frac{{e}^{- {E}_{t} ( {c}_{i} )}}{{e}^{- {E}_{b} ( {c}_{i} )}} .$$

Still referring to FIG. 4 and according to processing step 404, an unbiased estimate for the expectation value of A with respect to the distribution pₜ defined by the target Hamiltonian is computed using the results from processing steps 400 and 402 via

$${A}_{{p}_{t}} = \frac{{\tilde{A}}_{{p}_{t}}}{{r}_{b}^{t}} .$$

Now referring back to FIG. 3 and according to processing step 310, the estimated expectation value Aₚ_{ₜ} of the observable corresponding to the target Hamiltonian is provided. It will be appreciated that the estimated expectation value Aₚ_{ₜ} of the observable corresponding to the target Hamiltonian may be provided according to various embodiments. In one or more embodiments, the estimated expectation value Aₚ_{ₜ} of the observable corresponding to the target Hamiltonian is stored in the memory unit 22. In one or more alternative embodiments, the estimated expectation value Aₚ_{ₜ} of the observable corresponding to the target Hamiltonian is displayed on the display device 14. In one or more alternative embodiments, the estimated expectation value Aₚ_{ₜ} of the observable corresponding to the target Hamiltonian is provided to a remote processing device operatively connected to the digital computer 8. In fact and as further explained below, it will be appreciated that the estimated expectation value Aₚ_{ₜ} of the observable corresponding to the target Hamiltonian may be advantageously used in many embodiments.

If the end of a list of target Hamiltonians is not reached, processing steps 306, 308 and 310 are repeated using the same set of configuration samples {c₁}ᵢ₌₁^{N}^{ₛ} obtained from the probability distribution defined by the base Hamiltonian in the processing step 304. In one or more embodiments, the estimated expectation value of the observable comprises an energy expected value. In one or more embodiments, the estimated expectation value of the observable comprises an n-point function.

It will be appreciated that in one or more embodiments, the method further comprises using the estimated expectation value of the observable as a function approximator. It will be further appreciated that in one or more embodiments, the method further comprises estimating a thermodynamic property of a Hamiltonian and using thereof as a function approximator.

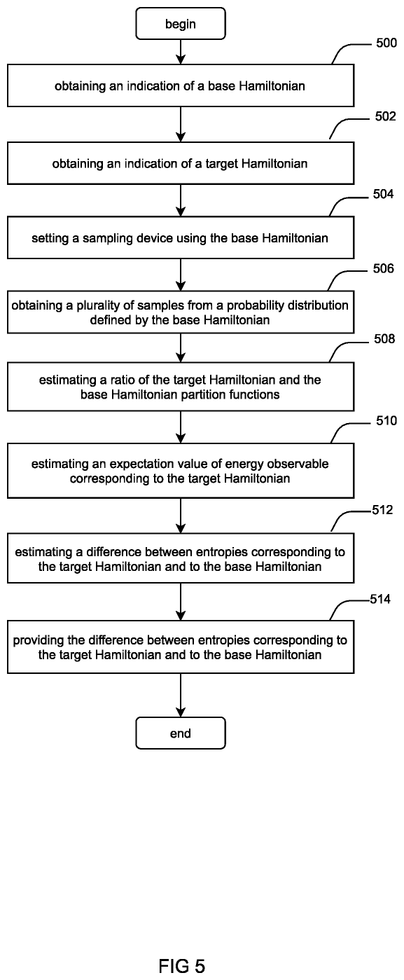

Now referring to FIG. 5, there is shown an embodiment of a method for estimating a difference between entropies of two models defined by a target Hamiltonian and a base Hamiltonian.

More precisely and according to processing step 500, an indication of a base Hamiltonian is obtained. It will be appreciated that the indication of a base Hamiltonian may be of various types. In one or more embodiments, the indication of the base Hamiltonian is a mathematical function representing the energy function.

It will be appreciated that the indication of the base Hamiltonian may be obtained according to various embodiments.

In one or more embodiments, the indication of the base Hamiltonian is obtained using the digital computer 8. It will be appreciated that the indication of the base Hamiltonian may be stored in the memory unit 22 of the digital computer 8.

In one or more alternative embodiments, the indication of the base Hamiltonian is provided by a user interacting with the digital computer 8.

In one or more alternative embodiments, the indication of the base Hamiltonian is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

It will be appreciated by the skilled addressee that the base Hamiltonian defines a physics model and the Boltzmann probability distribution corresponding to the model. More precisely, let E_{b} define the base Hamiltonian. It is defined via a classical energy function operating on the space of configurations. For a given configuration c, the base Hamiltonian outputs a real number representative of energy E_{b}(c). In one or more embodiments, a configuration c is a binary vector. The probability distribution corresponding to the base Hamiltonian over all possible configurations is specified by the Boltzmann distribution

$${p}_{b} ( c ) = \frac{{e}^{- {E}_{b} ( c )}}{{Z}_{b}} ,$$

where the normalizing constant, Z_{b}=Σᵢe^{-E(c}^{ᵢ}⁾, is the partition function.

Still referring to FIG. 5 and according to processing step 502, an indication of a target Hamiltonian Eₜ is obtained. The indication of the target Hamiltonian may be a mathematical function representing the energy function. It will be appreciated that the indication of the target Hamiltonian may be obtained according to various embodiments.

In one or more embodiments, the indication of the target Hamiltonian is obtained using the digital computer 8. It will be appreciated that the indication of the target Hamiltonian may be stored in the memory unit 22 of the digital computer 8.

In one or more alternative embodiments, the indication of the target Hamiltonian is provided by a user interacting with the digital computer 8.

In one or more alternative embodiments, the indication of the target Hamiltonian is obtained from a remote processing unit, not shown, operatively coupled with the digital computer 8. The remote processing unit may be operatively coupled with the digital computer 8 according to various embodiments. In one or more alternative embodiments, the remote processing unit is coupled with the digital computer 8 via a data network. The data network may be selected from a group consisting of a local area network, a metropolitan area network and a wide area network. In one or more embodiments, the data network comprises the Internet.

More precisely, let Eₜ be a target Hamiltonian. The skilled addressee will appreciate that the concepts of the partition function and Boltzmann probability distributions extend to the target Hamiltonian. However, it will be appreciated by the skilled addressee that unlike the base Hamiltonian, the sampling device will not be used to sample from the distribution defined by the target Hamiltonian. It will be appreciated by the skilled addressee that the configuration space of the target Hamiltonian is the same as that of the base Hamiltonian.

Still referring to FIG. 5 and according to processing step 504, a sampling device is set using the base Hamiltonian. It will be appreciated that the sampling device may be of various types. The skilled addressee will appreciate that the sampling device may comprise any physics-inspired computer described herein. For instance and in one or more embodiments, the sampling device comprises a NISQs device. It will be appreciated that the sampling device may be any suitable sampling device, such as any sampling device described herein with respect to the system shown in FIG. 1. It will be appreciated that the sampling device may be set in various ways which may depend on the type of the sampling device for example as disclosed elsewhere herein.

Still referring to FIG. 5 and according to the processing step 506, a plurality of samples from the probability distribution defined by the base Hamiltonian are obtained using the sampling device. It will be appreciated that the base Hamiltonian is such that it can be implemented on the sampling device. It will be further appreciated that the plurality of samples may be obtained in various ways which may depend on the type of the sampling device and the procedure used for the sampling from the Boltzmann distribution defined by the base Hamiltonian for example as disclosed elsewhere herein.

For a given E_{b}, the output of the sampling device is a plurality of configuration samples {c}ᵢ₌₁^{N}^{ₛ}, wherein Nₛ is the number of samples. It will be appreciated that in one or more embodiments, the number of samples Nₛ is provided by a user. The skilled addressee will appreciate that in the one or more embodiments, wherein the sampling device is a quantum computer, multiple measurements of the states of the qubits provide the plurality of samples from the probability distribution defined by the base Hamiltonian.

Still referring to FIG. 5 and according to processing step 508, a sample estimate for a ratio of the target Hamiltonian and the base Hamiltonian partition functions is computed using the obtained configuration samples {c}ᵢ₌₁^{N}^{ₛ}, which samples are from the probability distribution defined by the base Hamiltonian. More precisely, a sample estimate for a ratio of the base Hamiltonian and the target Hamiltonian partition functions is computed using the following

$${r}_{b}^{t} = \frac{1}{{N}_{s}} {Σ}_{i = 1}^{{N}_{s}} \frac{{e}^{- {E}_{t} ( {c}_{i} )}}{{e}^{- {E}_{b} ( {c}_{i} )}} .$$

According to processing step 510, an expectation value of energy observable [symbol] Eₜ [symbol] corresponding to the target Hamiltonian is estimated using any of the methods for estimating an expectation value of an observable disclosed herein.

Still referring to FIG. 5 and according to processing step 512, a difference between entropies corresponding to the target Hamiltonian and to the base Hamiltonian is estimated using the estimated ratio and the estimated expectation value of the energy observable corresponding to the target Hamiltonian. More precisely, the difference between entropies corresponding to the target Hamiltonian and the base Hamiltonian Sₜ−S_{b} is estimated using the following formula Sₜ−S_{b}=ln(r_{b}^{t})+β( [symbol] Eₜ [symbol] − [symbol] E_{b} [symbol] ). The skilled addressee will appreciate that ln(r_{b}^{t}) is the natural logarithm of the estimated ratio; β is an inverse temperature; and [symbol] E_{b} [symbol] may be estimated using the plurality of configuration samples using the empirical mean.

Still referring to FIG. 5 and according to processing step 514, the difference between entropies corresponding to the target Hamiltonian and to the base Hamiltonian is provided. It will be appreciated that the estimated difference between entropies corresponding to the target Hamiltonian and to the base Hamiltonian may be provided according to various embodiments. In one or more embodiments, the estimated difference between entropies corresponding to the target Hamiltonian and to the base Hamiltonian is stored in the memory unit 22. In one or more alternative embodiments, the estimated difference between entropies corresponding to the target Hamiltonian and to the base Hamiltonian is displayed on the display device 14. In one or more other embodiments, the estimated difference between entropies corresponding to the target Hamiltonian and to the base Hamiltonian is provided to a remote processing device operatively connected to the digital computer 8.

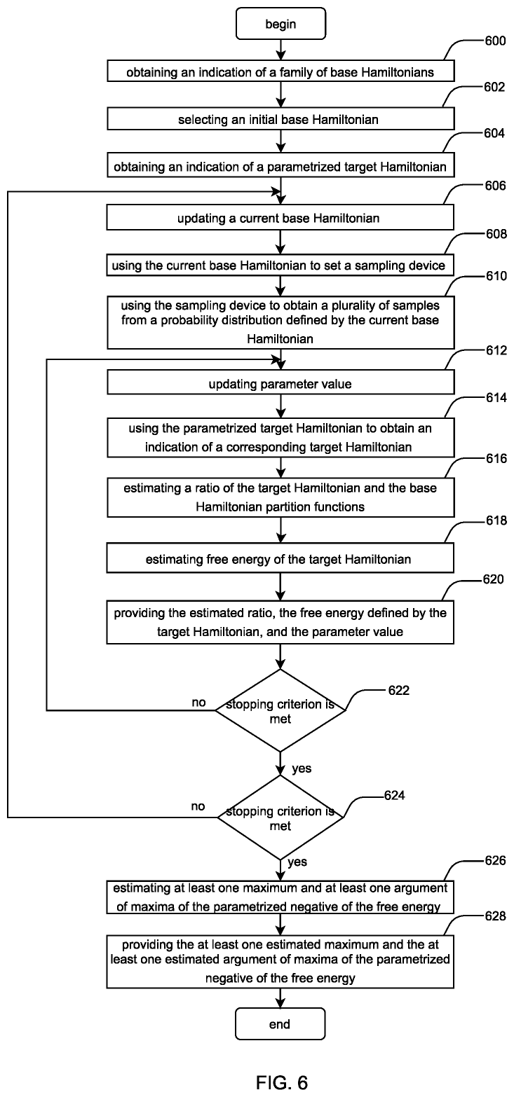

Now referring to FIG. 6 there is shown an embodiment of a method for estimating maxima and arguments of maxima of parametrized negative of free energy defined by a family of target Hamiltonians represented by a parametrized target Hamiltonian using a sampling device. It will be appreciated that the method disclosed herein provides estimates of the maxima and the arguments of maxima of the parametrized negative of free energy defined by a family of target Hamiltonians represented by the parametrized target Hamiltonian based on the samples generated by the sampling device configured to sample from the distribution defined by a base Hamiltonian selected from a family of base Hamiltonians.

More precisely, according to processing step 600, an indication of a family of base Hamiltonians is obtained. In one or more embodiments, the indication of the family of base Hamiltonians comprises a list of mathematical functions representing the energy function. In one or more other embodiments, the indication of the family of the base Hamiltonians comprises a mathematical function representing the parametrized energy function.

It will be appreciated that the indication of the family of base Hamiltonians may be obtained according to various embodiments.

In one or more embodiments, the indication of the family of base Hamiltonians is obtained using the digital computer 8. It will be appreciated that the indication of the family of base Hamiltonians may be stored in the memory unit 22 of the digital computer 8.

In one or more alternative embodiments, the indication of the family of base Hamiltonians is provided by a user interacting with the digital computer 8.

In one or more alternative embodiments, the indication of the family of base Hamiltonians is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

Still referring to FIG. 6 and according to processing step 602, an initial base Hamiltonian is selected from the family of the base Hamiltonians, and a current base Hamiltonian is set to be the initial base Hamiltonian. It will be appreciated that the initial base Hamiltonian may be any base Hamiltonian selected from a family of the base Hamiltonians. In one or more embodiments, the initial base Hamiltonian is selected at random. In one or more alternative embodiments, the initial base Hamiltonian is selected by a user. In one or more embodiments, the family of base Hamiltonians comprises one base Hamiltonian. In one or more alternative embodiments, the family of base Hamiltonians is represented by a parametrized base Hamiltonian.

It will be appreciated by the skilled addressee that each of the base Hamiltonians defines a physics model and the Boltzmann probability distribution corresponding to the model. More precisely, let E_{b} define the base Hamiltonian. It is defined via a classical energy function operating on the space of configurations. For a given configuration c, the base Hamiltonian outputs a real number representative of the energy E_{b}(c). In one or more embodiments, the configuration c is a binary vector. The probability distribution corresponding to the base Hamiltonian over all possible configurations is specified by the Boltzmann distribution

$${p}_{b} ( c ) = \frac{{e}^{- {E}_{b} ( c )}}{{Z}_{b}} ,$$

where the normalizing constant, Z_{b}=Eₜ e^{-E(c}^{ᵢ}⁾, is the partition function.

Still referring to FIG. 6 and according to processing step 604 an indication of a parametrized target Hamiltonian is obtained. It will be appreciated that the indication of the parametrized target Hamiltonian may be a mathematical function representing the energy function. It will be appreciated that the indication of the parametrized target Hamiltonian may be obtained according to various embodiments.

In one or more embodiments, the indication of the parametrized target Hamiltonian is obtained using the digital computer 8. It will be appreciated that the indication of the parametrized target Hamiltonian may be stored in the memory unit 22 of the digital computer 8.

In one or more alternative embodiments, the indication of the parametrized target Hamiltonian is provided by a user interacting with the digital computer 8.

In one or more alternative embodiments, the indication of the parametrized target Hamiltonian is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

More precisely, let E_{t,a} be a parametrized target Hamiltonian. Herein, the target Hamiltonian is parametrized by parameter a. It will be appreciated that the parameter may be a vector of any finite dimension, comprising elements which may take either discrete or continues values.

The concepts of the Boltzmann probability distributions and samples introduced for the base Hamiltonian extend to the parametrized target Hamiltonian. However, unlike the base Hamiltonian, it will be appreciated by the skilled addressee that the sampling device will not be used to sample from the distribution defined by the parametrized target Hamiltonian for any value of the parameter a. It will be appreciated by the skilled addressee that the configuration space of the parametrized target Hamiltonian is the same as that of the base Hamiltonian for any value of the parameter a.

Still referring to FIG. 6 and according to processing step 606, a current base Hamiltonian E_{b}^{c} is updated. It will be appreciated that the current base Hamiltonian is set to be the initial base Hamiltonian selected in processing step 602 in case the processing step 506 is performed for the first time in the course of the method.

If processing step 606 is being repeated, the current base Hamiltonian is updated using an optimization protocol in accordance with one or more embodiments. It will be appreciated by the skilled addressee that various optimization protocols may be used to update the current base Hamiltonian. In one or more non-limiting embodiments, the optimization protocol is at least one member selected from a group consisting of a gradient descent, a stochastic gradient descent, a local search, a random search, a steepest descent and a Bayesian optimization. In one or more embodiments, the current base Hamiltonian is updated using at least one protocol based on a gradient based method. In one or more embodiments, the current base Hamiltonian is updated using at least one optimization protocol based on a derivative free method. It will be further appreciated that the current base Hamiltonian is updated using the optimization protocol using the ratios estimated during processing step 616, the free energies defined by the target Hamiltonians estimated during processing step 618, and the corresponding parameter value(s). In one or more embodiments, the current base Hamiltonian is updated with the parameter value of the target Hamiltonian with the largest ratio r_{b,c}^{t,a}*, , provided this ratio is greater than one. More precisely, if a*=argmaxₐr_{b,c}^{t,a} and r_{b,c}^{t,a}*>1 then E_{b}^{c}=E_{t,a}.

Still referring to FIG. 6 and according to processing step 608, a sampling device is set using the current base Hamiltonian E. It will be appreciated that the sampling device may be of various types. In fact, the skilled addressee will appreciate that the sampling device may comprise any physics-inspired computer described herein. For instance and in accordance with one or more embodiments, the sampling device comprises a NISQs device. It will be appreciated that the sampling device may be any suitable sampling device, such as any sampling device described herein with respect to the system shown in FIG. 1. It will be appreciated that the sampling device may be set in various ways which may depend on the type of the sampling device for example as disclosed elsewhere herein.

Still referring to FIG. 6 and according to the processing step 610, a plurality of samples is obtained using the sampling device from a probability distribution defined by the current base Hamiltonian. It will be appreciated that the current base Hamiltonian is such that it can be implemented on the sampling device. It will be further appreciated that the plurality of samples may be obtained in various ways which may depend on the type of sampling device and the procedure used for the sampling from the Boltzmann distribution defined by the base Hamiltonian for example as disclosed elsewhere herein.

For a given E_{b}, the output of the sampling device is a plurality of configuration samples {c}ᵢ₌₁^{N}^{ₛ}, wherein Nₛ is the number of samples. It will be appreciated that in one or more embodiments, the number of samples Nₛ is provided by a user. The skilled addressee will appreciate that in the one or more embodiments, wherein the sampling device is a quantum computer, multiple measurements of the states of the qubits provide the plurality of samples from the probability distribution defined by the base Hamiltonian.

According to processing step 612, a parameter value is updated. It will be appreciated that the parameter value is updated with an initial parameter value if processing step 612 is processed for the first time for the current base Hamiltonian. The initial parameter value may be selected in various ways. In one or more embodiments, the initial parameter value is selected at random. In one or more alternative embodiments, the initial parameter value is provided by a user.

If processing step 612 is being repeated for the current base Hamiltonian, the parameter value is updated using an optimization protocol. It will be appreciated by the skilled addressee that various optimization protocols may be used for updating the parameter value. In fact, it will be appreciated that in one or more embodiments, the optimization protocol is at least one member selected from a group consisting of a gradient descent, a stochastic gradient descent, a local search, a random search, a steepest descent and a Bayesian optimization. In one or more embodiments, the updating of the parameter value is performed using at least one optimization protocol based on a gradient based method. In one or more alternative embodiments, the updating of the parameter value is performed using at least one optimization protocol based on a derivative free method. It will be further appreciated that the parameter value is updated using the optimization protocol using the ratios estimated during processing step 616, the free energies defined by the target Hamiltonians estimated during processing step 618, and the previous parameter value(s). In one or more embodiments, the parameter value is updated using a local search around the current parameter value.

Still referring to FIG. 6 and according to processing step 614, an indication of a target Hamiltonian corresponding to the parameter value is obtained. It will be appreciated that the indication of a target Hamiltonian corresponding to the parameter value is obtained using the parametrized target Hamiltonian.

According to processing step 616, a ratio of the target Hamiltonian corresponding to the parameter value and the current base Hamiltonian partition functions is estimated using the obtained samples of the probability distribution defined by the obtained base Hamiltonian. A sample estimate for a ratio of the target Hamiltonian corresponding to the parameter value and the current base Hamiltonian partition functions is computed. The sample ratio is computed using the obtained configuration samples {c}ᵢ₌₁^{N}^{ₛ}, which samples are from the probability distribution defined by the current base Hamiltonian. More precisely, a sample estimate for a ratio of the current base Hamiltonian and the target Hamiltonian corresponding to the parameter value partition functions is computed using the following equation

$${r}_{b , c}^{t , a} = \frac{1}{{N}_{s}} {Σ}_{i = 1}^{{N}_{s}} \frac{{e}^{- {E}_{t , a} ( {c}_{i} )}}{{e}^{- {E}_{b}^{c} ( {c}_{i} )}} .$$

Still referring to FIG. 6 and according to processing step 618, the free energy of the target Hamiltonian is estimated. It will be appreciated that the free energy of the target Hamiltonian is estimated using the following formula ln((r_{b,c}^{t,a}))+ln(Z_{b}^{c}), wherein Z_{b}^{c}, is the partition function corresponding to the current base Hamiltonian. It will be appreciated that ln((r_{b,c}^{t,a})) is the natural logarithm of the estimated ratio.

Still referring to FIG. 6 and according to processing step 620, the estimated ratio, the free energy defined by the obtained target Hamiltonian corresponding to the parameter value and the parameter value are provided.

According to decision step 622, if a first stopping criterion is not met processing steps 612, 614, 616, 618 and 620 are repeated using the same set of configuration samples {c₁}ᵢ₌₁^{N}^{ₛ} obtained from the probability distribution defined by the current base Hamiltonian in the processing step 610. It will be appreciated that the first stopping criterion may be of various types. In one or more embodiments, the first stopping criterion is that the parameter value has converged to a certain value. In one or more alternative embodiments, the first stopping criterion is that processing steps 612, 614, 616, 618 and 520 are repeated a given number of times.

If a second stopping criterion is not met and according to decision step 624, processing steps 606-620 and decision step 622 are repeated. It will be appreciated that the second stopping criterion may be of various types. In one or more embodiments, the second stopping criterion is that the parameter of the parametrized base Hamiltonian representative of the family of the base Hamiltonians has converged to a certain value. In one or more alternative embodiments, the second stopping criterion is processing steps 606-620 and decision step 622 are repeated a given number of times.

Still referring to FIG. 6 and according to processing step 626, at least one maximum and at least one argument of maxima of parametrized negative of free energy defined by the parametrized target Hamiltonian are estimated. The skilled addressee will appreciate that the maxima and the arguments of maxima may be estimated in various ways. In one or more embodiments, the maxima and the arguments of maxima are estimated by comparing the ratios estimated during processing step 616. In one or more alternative embodiments, the negative of the free energy estimated during processing step 618 is stored together and updated during the repetition of processing step 618, in case the new estimated negative of the free energy is greater. In one or more alternative embodiments, the last estimated negative of free energy is provided.

According to processing step 628, the at least one estimated maximum and the at least one argument of maxima of the parametrized negative of free energy defined by the parametrized target Hamiltonian are provided. It will be appreciated that the at least one estimated maximum and the at least one argument of maxima of the parametrized negative of free energy defined by the parametrized target Hamiltonian may be provided according to various embodiments. In one or more embodiments, the at least one estimated maximum and the at least one argument of maxima of the parametrized negative of free energy defined by the parametrized target Hamiltonian are stored in the memory unit 22. In one or more alternative embodiments, the at least one estimated maximum and the at least one argument of maxima of the parametrized negative of free energy defined by the parametrized target Hamiltonian are displayed on the display device 14. In one or more alternative embodiments, the at least one estimated maximum and the at least one argument of maxima of the parametrized negative of free energy defined by the parametrized target Hamiltonian are provided to a remote processing device operatively connected to the digital computer 8.

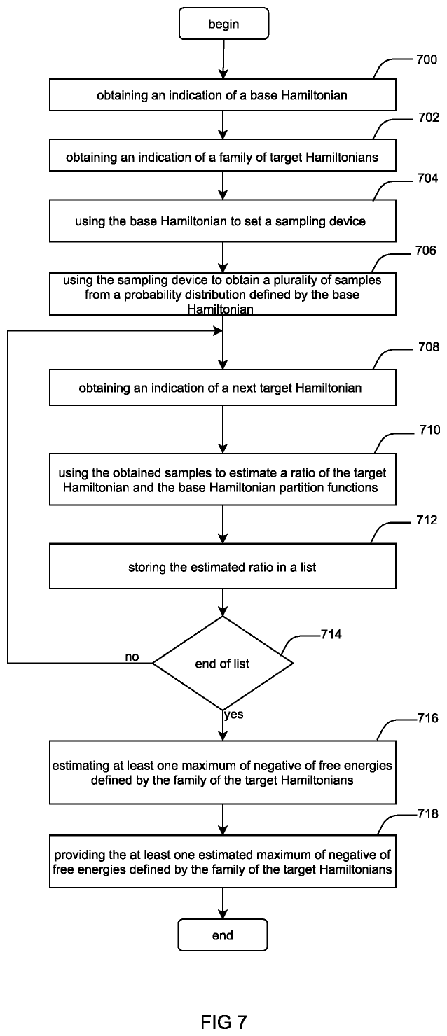

Now referring to FIG. 7, there is shown an embodiment of a method for estimating maxima of negative of free energies defined by a family of target Hamiltonians. The method disclosed herein provides estimates of the maxima of the negative of the free energies defined by the family of the target Hamiltonians based on the samples generated by the sampling device configured to sample from the distribution defined by a base Hamiltonian.

Still referring to FIG. 7 and according to processing step 700, an indication of the base Hamiltonian is obtained. It will be appreciated that the indication of the base Hamiltonian may be of various types. In one or more embodiments, the indication of the base Hamiltonian is a mathematical function representing the energy function.

It will be appreciated that the indication of the base Hamiltonian may be obtained according to various embodiments.

In one or more embodiments, the indication of the base Hamiltonian is obtained using the digital computer 8. It will be appreciated that the indication of the base Hamiltonian may be stored in the memory unit 22 of the digital computer 8.

In one or more alternative embodiments, the indication of the base Hamiltonian is provided by a user interacting with the digital computer 8.

In one or more alternative embodiments, the indication of the base Hamiltonian is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

It will be appreciated by the skilled addressee that the base Hamiltonian defines a physics model and the Boltzmann probability distribution corresponding to the model. More precisely, let E_{b} define the base Hamiltonian. It is defined via a classical energy function operating on the space of configurations. For a given configuration c, the base Hamiltonian outputs a real number representative of the energy E_{b}(c). In one or more embodiments, the configuration c is a binary vector. The probability distribution corresponding to the base Hamiltonian over all possible configurations is specified by the Boltzmann distribution

$${p}_{b} ( c ) = \frac{{e}^{- {E}_{b} ( c )}}{{Z}_{b}} ,$$

where the normalizing constant, Z_{b}=Eₜ e^{-E(c}^{ᵢ}⁾, is the partition function.

Still referring to FIG. 7 and according to processing step 702, an indication of a family of target Hamiltonians is obtained. It will be appreciated that the indication of the family of the target Hamiltonians may comprise a list of mathematical functions representing the energy functions. It will be appreciated that the indication of the family of target Hamiltonians may be obtained according to various embodiments.

In one or more embodiments, the indication of the family of target Hamiltonians is obtained using the digital computer 8. It will be appreciated that the indication of the family of the target Hamiltonians may be stored in the memory unit 22 of the digital computer 8.

In one or more alternative embodiments, the indication of the family of target Hamiltonians is provided by a user interacting with the digital computer 8.

In one or more alternative embodiments, the indication of the family of the target Hamiltonians is obtained from a remote processing unit, not shown, operatively coupled with the digital computer 8. The remote processing unit may be operatively coupled with the digital computer 8 according to various embodiments. In one or more embodiments, the remote processing unit is coupled with the digital computer 8 via a data network. The data network may be selected from a group consisting of a local area network, a metropolitan area network and a wide area network. In one or more embodiments, the data network comprises the Internet.

Still referring to FIG. 7 and according to processing step 704, the sampling device is set using the base Hamiltonian.

It will be appreciated that the sampling device may be of various types. The skilled addressee will appreciate that the sampling device may comprise any physics-inspired computer described herein. For instance and in one or more embodiments, the sampling device comprises a NISQs device. It will be appreciated that the sampling device may be any suitable sampling device, such as any sampling device described herein with respect to the system shown in FIG. 1. It will be appreciated that the sampling device may be set in various ways which may depend on the type of the sampling device for example as disclosed elsewhere herein.

According to processing step 706, a plurality of samples from a probability distribution defined by the base Hamiltonian are obtained using the sampling device. It will be appreciated by the skilled addressee that the base Hamiltonian is such that it can be implemented on the sampling device. It will be further appreciated that the plurality of samples may be obtained in various ways which may depend on the type of the sampling device and the procedure used for the sampling from the Boltzmann distribution defined by the base Hamiltonian for example as disclosed elsewhere herein.

For a given E_{b}, the output of the sampling device is a plurality of configuration samples {c}ᵢ₌₁^{N}^{ₛ}, wherein Nₛ is the number of samples. It will be appreciated that in one or more embodiments, the number of samples Nₛ is provided by a user. The skilled addressee will appreciate that in the one or more embodiments, wherein the sampling device is a quantum computer, multiple measurements of the states of the qubits provide the plurality of samples from the probability distribution defined by the base Hamiltonian.

According to processing step 708, an indication of a next target Hamiltonian is obtained. In one or more embodiments, the indication of the next target Hamiltonian is a mathematical function representing the energy function.

More precisely, let Eₜ be a target Hamiltonian. The concepts of the Boltzmann probability distributions and samples introduced above for the base Hamiltonian extend to the target Hamiltonian as well. However, unlike the base Hamiltonian, it will be appreciated by the skilled addressee that the sampling device will not be used to sample from the distribution defined by the target Hamiltonian. It will be appreciated by the skilled addressee that the configuration space of the target Hamiltonian is the same as that of the base Hamiltonian.

Still referring to FIG. 7 and according to the processing step 710, a ratio of the target Hamiltonian and the base Hamiltonian partition functions is estimated using the obtained samples from the probability distribution defined by the base Hamiltonian and the following equation

$${r}_{b}^{t} = \frac{1}{{N}_{s}} {Σ}_{i = 1}^{{N}_{s}} \frac{{e}^{- {E}_{t} ( {c}_{i} )}}{{e}^{- {E}_{b} ( {c}_{i} )}} .$$

According to processing step 712, the estimated ratio is stored in a list.

According to decision step 714 a test is performed to find out if the end of a list representative of a family of the target Hamiltonians is reached or not. If the end of the list representative of the family of the target Hamiltonians is not reached processing steps 708, 710 and 712 are repeated using the same set of configuration samples {c₁}ᵢ₌₁^{N}^{ₛ} obtained from the probability distribution defined by the base Hamiltonian in the processing step 606.

In the case where the end of the list representative of a family of the target Hamiltonians is reached and according to processing step 716, at least one estimated maximum of negative of free energies defined by the family of the target Hamiltonians is estimated. It will be appreciated that the at least one estimated maximum of negative of free energies defined by the family of the target Hamiltonians may be estimated according to various embodiments. In one or more embodiments, the at least one estimated maximum of negative of free energies defined by the family of the target Hamiltonians is estimated by comparing all the estimated ratios provided in processing step 712; by selecting the maximal estimated ratio(s) max(r_{b}^{t}); and by estimating the corresponding maximum of negative of free energies using the following equation ln(max(r_{b}^{t}))+lnZ_{b}. It will be appreciated that ln((r_{b,c}^{t,a})) is the natural logarithm of the estimated ratio.

In one or more alternative embodiments, the maximal estimated ratio value is stored and is updated by the next ratio estimated for the target Hamiltonian in the family of the target Hamiltonians in processing step 710.

Still referring to FIG. 7 and according to processing step 718, the at least one estimated maximum of negative of free energies defined by the family of the target Hamiltonians is provided. It will be appreciated that the at least one estimated maximum of negative of free energies defined by the family of the target Hamiltonians may be provided according to various embodiments. In one or more embodiments, the at least one estimated maximum of negative of free energies defined by the family of the target Hamiltonians is stored in the memory unit 22. In one or more alternative embodiments, the at least one estimated maximum of negative of free energies defined by the family of the target Hamiltonians is displayed on the display device 14. In one or more other embodiments, the at least one estimated maximum of negative of free energies defined by the family of the target Hamiltonians is provided to a remote processing device operatively connected to the digital computer 8.

### Reinforcement Learning Application

Reinforcement learning (RL) is a field of machine learning concerned with how software agents ought to take actions in an environment in order to maximize a notion of utility function representative of cumulative reward. Reinforcement learning is studied in many disciplines, such as game theory, control theory, operations research, information theory, simulation-based optimization, multi-agent systems, swarm intelligence, statistics and genetic algorithms. In the operations research and control literature, reinforcement learning is also referred to as approximate dynamic programming, or neuro-dynamic programming. In economics and game theory, reinforcement learning may be used to explain how equilibrium may arise under bounded rationality.

The environment is usually defined in the form of a Markov decision process (MDP). One embodiment can be found in the US patent application number U.S. Ser. No. 15/590,614 which is incorporated herein by reference.

More precisely, the reinforcement learning framework comprises at least one software agent, an environment and interactions of the software agent with the environment. Furthermore, the environment comprises states and instantaneous rewards and the interactions of the agent with the environment comprise actions. The software agent aims to maximize cumulative instantaneous rewards using at least one utility function representative of the cumulative instantaneous rewards.

It will be appreciated that the states and actions may take both discrete and continuous values. The number of states and actions may be any finite number.

The skilled addressee will appreciate that the instantaneous reward may be of various types. In fact, it will be appreciated that the number representative of the instantaneous reward may be one of discrete and continuous. It will be further appreciated that the instantaneous reward depends on the states. It may be one of deterministic and stochastic.

It will be appreciated that the utility function may be of various types. For instance and in accordance with one or more embodiments, the utility function is a Q-function. In one or more alternative embodiments, the utility function is a value function. In one or more alternative embodiments, the utility function is a generalized advantage estimator.

It will be appreciated by the skilled addressee that a training procedure within the reinforcement learning framework may be of various types. For instance and in accordance with one or more embodiments, the training procedure is implemented based on at least one algorithm selected from a group of algorithms consisting of a TD learning algorithm, a Q-learning algorithm, a Q-learning Lambda algorithm, a state-action-reward-state-action (SARSA) algorithm, a state-action-reward-state-action (SARSA) Lambda algorithm, a deep Q network (DQN) algorithm, a deep deterministic policy gradient (DDPG) algorithm, an asynchronous advantage actor-critic (A3C) algorithm, a soft actor-critic (SAC) algorithm, a Q-learning with normalized advantage functions (NAF) algorithm, a trust region policy optimization (TRPO) algorithm, a proximal policy optimization (PPO) algorithm and a twin delayed deep deterministic policy gradient (TD3) algorithm.

It will be appreciated that a function approximation technique may be used in a training procedure based on any of the above algorithms. A function approximation technique may comprise using any suitable approximator, such as any observable described herein with respect to FIG. 3. The approximator may be estimated using any method, such as any method described herein with respect to FIG. 3. A suitable approximator may be any thermodynamic property, such as any thermodynamic property described herein. In one or more embodiments, the thermodynamic property used as the function approximator is negative of free energy. The function approximator comprises an implicit parametrized representation of the utility function. In one or more embodiments, the function approximator is the free energy of the Boltzmann machine. In this embodiment, the implicit parameters of the function approximator are the weights of the Boltzmann machine and the states and the actions are represented by the visible nodes of the Boltzmann machine. In one or more alternative embodiments, the function approximator is the free energy of a deep multi-layer Boltzmann machine where its visible nodes are outputs of a Neural Network whose inputs are states and actions representatives and its weights are the implicit parameters of the function approximator.

The skilled addressee will appreciate that estimating actions maximizing the utility function may be used in the course of the training procedure. More precisely, finding/estimating at least one maximum and arguments of maxima of the utility function with respect to the parameters representative of the actions may be required to perform a step within the training procedure. It will be appreciated by the skilled addressee that any method may be used for estimating the at least one maximum and the arguments of maxima of the utility function with respect to the parameters representative of the actions. In one or more embodiments wherein the negative of free energy is used as a function approximator, any method for estimating the at least one maximum and the arguments of maxima of the free energy may be used, such as any method described herein with respect to FIG. 6. In such embodiments, the target Hamiltonian is parametrized with a parameter representative of the actions.

There is therefore disclosed a use of one or more embodiments of a method disclosed herein for a training procedure within a reinforcement learning framework comprising: an agent in pursuit of optimizing at least one utility function, an environment comprising states and instantaneous reward and interactions of the agent with the environment comprising actions; wherein the instantaneous rewards contribute to the at least one utility function; the use comprising approximating the at least one utility function and estimating an action maximizing the at least one utility function corresponding to a provided state. In one or more embodiments, the at least one utility function is selected from a group consisting of a value function, a Q-function and a generalized advantage estimator.

It will be appreciated that one or more embodiments of the methods disclosed herein are of great advantage for various reasons.

More precisely, an advantage of one or more embodiments of the methods disclosed herein is that they extend the functionality of a sampling device to estimate observables of the models which are not configurable on the device.

Another advantage of one or more embodiments of the methods disclosed herein is that they enable comparing of various models using entropies.

Another advantage of one or more embodiments of the methods disclosed herein is that they enable estimating maximum and the arguments of maxima of negative free energy of family of Hamiltonians using only one sampling.

Another advantage of one or more embodiments of the methods disclosed herein is that they may be implemented using various sampling devices.

Another advantage of the methods disclosed herein is that it may be applied in reinforcement learning.

1. A method for estimating an expectation value of an observable of at least one target Hamiltonian using a base Hamiltonian, the method comprising:
a. obtaining an indication of a base Hamiltonian and an indication of an observable;
b. setting a sampling device using the base Hamiltonian;
c. using said sampling device to obtain a plurality of samples from a probability distribution defined by the base Hamiltonian;
d. for each target Hamiltonian of a list of at least one target Hamiltonian:
i. using the obtained plurality of samples from the probability distribution defined by the base Hamiltonian to estimate an expectation value of the observable corresponding to the target Hamiltonian comprising:
1. computing a sample estimate of a ratio of partition functions of the target Hamiltonian and the base Hamiltonian,
2. computing an unnormalized estimate for an expectation value of the observable with respect to the probability distribution defined by the target Hamiltonian,
3. using the estimated ratio of partition functions and the unnormalized estimated expectation value to compute an estimate for an expectation value of the observable with respect to the probability distribution defined by the target Hamiltonian; and
ii. providing the estimated expectation value of the observable corresponding to the target Hamiltonian.

2. A method for estimating maxima and arguments of maxima of parametrized negative of free energy defined by a family of target Hamiltonians represented by a parametrized target Hamiltonian, the method comprising:
a. obtaining an indication of a family of base Hamiltonians;
b. selecting an initial base Hamiltonian from the family of base Hamiltonians;
c. obtaining an indication of a parametrized target Hamiltonian;
d. until a first stopping criterion is met:
i. updating a current base Hamiltonian;
ii. using the current base Hamiltonian to set a sampling device;
iii. using the sampling device to obtain a plurality of samples from a probability distribution defined by the current base Hamiltonian;
iv. selecting an initial parameter value;
v. until a second stopping criterion is met:
1. updating a parameter value,
2. using the parametrized target Hamiltonian to obtain an indication of a target Hamiltonian corresponding to the parameter value,
3. using the obtained samples from the probability distribution defined by the obtained base Hamiltonian to estimate a ratio of the target Hamiltonian corresponding to the parameter value and the current base Hamiltonian partition functions,
4. estimating a free energy of the target Hamiltonian,
5. providing the estimated ratio, the free energy defined by the obtained target Hamiltonian, and the corresponding parameter value;
e. estimating at least one maximum and at least one argument of maxima of parametrized negative of free energy defined by the parametrized target Hamiltonian; and
f. providing the at least one estimated maximum and the at least one estimated argument of maxima of the parametrized negative of free energy.

3. The method as claimed in claim 2, wherein the family of base Hamiltonians comprises one base Hamiltonian.

4. The method as claimed in claim 2, wherein the family of base Hamiltonians is represented by a parametrized base Hamiltonian.

5. The method as claimed in claim 2, wherein at least one of the current base Hamiltonian and of the parameter value is updated using at least one optimization protocol based on one of a gradient based method and a derivative free method.

6. The method as claimed in claim 2, wherein at least one of the current base Hamiltonian and of the parameter value is updated using at least one optimization protocol based on a method selected from the group consisting of a gradient descent, a stochastic gradient descent, a steepest descent, a Bayesian optimization, a random search and a local search.

7. A method for estimating maxima of negative of free energies defined by a family of target Hamiltonians using samples from a base Hamiltonian, the method comprising:
obtaining an indication of a base Hamiltonian;
obtaining an indication of a family of target Hamiltonians;
using the base Hamiltonian to set a sampling device using the base Hamiltonian;
using the sampling device to obtain samples from a probability distribution defined by the base Hamiltonian;
for each target Hamiltonian of a list of target Hamiltonians representative of the family of target Hamiltonians:
using the obtained samples from the probability distribution defined by the base Hamiltonian to estimate a ratio of the target Hamiltonian and the base Hamiltonian partition functions;
storing the estimated ratio in a list;
using the list of the estimated ratios to estimate at least one maximum of negative of free energies defined by the family of the target Hamiltonians;
providing the at least one estimated maximum of the negative of free energies defined by the family of the target Hamiltonians.

8. A method for estimating a difference between entropies of two models defined by a target Hamiltonian and a base Hamiltonian using a sampling device, the method comprising:
obtaining an indication of a base Hamiltonian;
obtaining an indication of a target Hamiltonian;
setting a sampling device using the base Hamiltonian;
obtaining a plurality of samples from a probability distribution defined by the base Hamiltonian using the sampling device;
estimating a ratio of the target Hamiltonian and the base Hamiltonian partition functions using the obtained samples;
estimating an expectation value of the energy observable corresponding to the target Hamiltonian using processing steps d.i.1., d.i.2., and d.i.3. of claim 1;
estimating a difference between entropies corresponding to the target Hamiltonian and to the base Hamiltonian using the estimated ratio and the estimated expectation value of the energy observable corresponding to the target Hamiltonian; and
providing the estimated difference between entropies corresponding to the target Hamiltonian and to the base Hamiltonian.

9. The method as claimed in claim 1, wherein the estimated expectation value of the observable comprises one of an energy function expected value and an n-point function.

10. The method as claimed in claim 1, wherein the sampling device comprises at least one member of a group consisting of a a quantum processor, a quantum computer, a quantum annealer, a noisy intermediate-scale quantum device, a trapped ion quantum computer, a superconductor-based quantum computer, a spin-based quantum dot computer, a digital annealer, an optical computing device, and an integrated photonic coherent lsing machine.

11. The method as claimed in claim 2, wherein the sampling device comprises at least one member of a group consisting of a a quantum processor, a quantum computer, a quantum annealer, a noisy intermediate-scale quantum device, a trapped ion quantum computer, a superconductor-based quantum computer, a spin-based quantum dot computer, a digital annealer, an optical computing device, and an integrated photonic coherent lsing machine.

12. The method as claimed in claim 7, wherein the sampling device comprises at least one member of a group consisting of a a quantum processor, a quantum computer, a quantum annealer, a noisy intermediate-scale quantum device, a trapped ion quantum computer, a superconductor-based quantum computer, a spin-based quantum dot computer, a digital annealer, an optical computing device, and an integrated photonic coherent lsing machine.

13. The method as claimed in claim 8, wherein the sampling device comprises at least one member of a group consisting of a a quantum processor, a quantum computer, a quantum annealer, a noisy intermediate-scale quantum device, a trapped ion quantum computer, a superconductor-based quantum computer, a spin-based quantum dot computer, a digital annealer, an optical computing device, and an integrated photonic coherent lsing machine.

14. The method as claimed in claim 1, further comprising using the estimated expectation value of the observable to estimate a thermodynamic property of a Hamiltonian and using thereof as a function approximator.

15. The method as claimed in claim 2, further comprising using the free energy as a function approximator.

16. The method as claimed in claim 7, further comprising using the free energy as a function approximator.

17. Use of the method as claimed in claim 2 for a training procedure within a reinforcement learning framework comprising (i) an agent in pursuit of optimizing at least one utility function, (ii) an environment comprising states and instantaneous rewards and (iii) interactions of the agent with the environment comprising actions; wherein the instantaneous rewards contribute to the at least one utility function; the use comprising approximating the at least one utility function and estimating an action maximizing the at least one utility function corresponding to a provided state.

18. The use claimed in claim 17, wherein the at least one utility function is selected from a group consisting of a value function, a Q-function and a generalized advantage estimator.

19. Use of the method as claimed in claim 1 for a training procedure within a reinforcement learning framework, the reinforcement learning framework comprising (i) an agent in pursuit of optimizing at least one utility function, (ii) an environment comprising states and instantaneous rewards and (iii) interactions of the agent with the environment comprising actions; wherein the instantaneous rewards contribute to the at least one utility function; the use comprising approximating the at least one utility function and estimating an action maximizing the at least one utility function corresponding to a provided state.

20. Use of the method as claimed in claim 7 for a training procedure within a reinforcement learning framework, the reinforcement learning framework comprising (i) an agent in pursuit of optimizing at least one utility function, (ii) an environment comprising states and instantaneous rewards and (iii) interactions of the agent with the environment comprising actions; wherein the instantaneous rewards contribute to the at least one utility function; the use comprising approximating the at least one utility function and estimating an action maximizing the at least one utility function corresponding to a provided state.
